(19) United States
(12) Patent Application Publication
(10) Pub. No.: US 2009/0055760 A1
(43) Pub. Date: Feb. 26, 2009

(54) SYSTEM AND METHOD FOR CREATING A USER INTERFACE

(75) Inventors: Michael Everett Whatcott, Lehi, UT (US); Peter L. Taylor, Orem, UT (US); John McDaniel, Ceder Hills, UT (US); Ryan Knowlton, Orem, UT (US)

Correspondence Address: MCCARTER & ENGLISH , LLP STAMFORD OFFICE, FINANCIAL CENTRE , SUITE 304A, 695 EAST MAIN STREET, STAMFORD, CT, 06901-2138, US

(73) Assignee: VANTAGE CONTROLS, INC., Orem, UT (US)

(21) Appl. No.: 11/840,601

(22) Filed: Aug. 17, 2007

Related U.S. Application Data
(60) Provisional application No. 60/838,796, filed on Aug. 17, 2006.

(51) Int. Cl. G06F 3/048

(52) U.S. Cl. 715/764

(57) ABSTRACT

The present disclosure provides for systems and methods for facilitating the design, creation and/or implementation of a user interface for processor programs. More particularly, the present disclosure provides for systems and methods for creating at least one user interface for processor programs for controlling devices and/or for controlling (e.g., managing or playing) or utilizing media or data files. In one embodiment, the present disclosure provides for systems and methods for creating at least one user interface for control systems or automation systems or the like.

### CROSS REFERENCE TO RELATED APPLICATIONS

This application claims the benefit of U.S. Provisional Application No. 60/838,796 filed Aug. 17, 2006, all of which is herein incorporated in its entirety.

### REFERENCE TO A COMPUTER PROGRAM LISTING COMPACT DISC APPENDIX

This application includes a computer program listing appendix, submitted herewith. The content of the computer program listing appendix is hereby incorporated by reference in its entirety and forms a part of this specification. The computer program listing appendix contains the following files:

| File Name | Size | | Date of Creation |
|---|---|---|---|
| Program A | 281,209 | KB | Aug. 17, 2007 |
| Program B | 4,232 | KB | Aug. 17, 2007 |
| Program C | 46,620 | KB | Aug. 17, 2007 |
| Program D | 95,241 | KB | Aug. 17, 2007 |

The inclusion of a computer program listing herein is merely exemplary and is not intended to be limiting of the scope of the present disclosure.

### TECHNICAL FIELD

The present disclosure relates to user interfaces for processor programs. More particularly, the present disclosure relates to systems and methods for creating a user interface for processor programs for controlling devices and/or for controlling (e.g., managing or playing) or utilizing media or data files.

### BACKGROUND

In general, a user interface is the physical means of communication between a person and a processor program, e.g., a software program. It is typically accepted that the user interface may make a difference in the perceived utility of a system (e.g., a control or automation system, or a media server and/or media player system) regardless of the system's actual performance. For example, in a basic form, a user interface generally involves the exchange of typed statements or a program-like set of commands between a user and a software program. Some user interfaces are graphical user interfaces (“GUI”) that allow a user to interact with a processor program by manipulating icons or menus or the like. For example, a user may interact with a GUI using a mouse, touchscreen, or other pointing device or the like.

Some software programs are available for designing custom user interfaces for control systems or automation systems or the like. Typically, these programs have involved beginning with a blank work area and dragging and dropping graphical icons onto the work area. Generally, each graphical icon must then be individually associated with each controlled device through additional programming. For example, where hundreds of controlled devices (e.g., controlled electrical devices) are present, this may be an extremely time-consuming and cost prohibitive task. Thus, it is desirable to eliminate the time and costs associated with developing or creating customized user interfaces for control systems or automation systems or the like.

In addition, some media server and/or media player applications include their own user interface for allowing a user to utilize the features of the media server and/or media player applications. However, users sometimes desire their own customized user interface for interfacing with the media server and/or media player applications. In addition, users sometimes desire their own customized user interface for interfacing with the media server and/or media player applications from a remote location. Thus, it is desirable to allow a user to create their own customized user interface for interfacing with media server and/or media player applications. In addition, it is desirable to allow a user to create their own customized user interface for remote devices that have the ability to interface with media server and/or media player applications from remote locations.

These and other needs are addressed and/or overcome by the systems and methods of the present disclosure.

### SUMMARY

The present disclosure provides advantageous user interfaces for processor programs. In exemplary embodiments, the present disclosure provides for systems and methods for creating at least one user interface for processor programs for controlling devices and/or for controlling (e.g., managing or playing) or utilizing media or data files.

The present disclosure provides for a system for creating a user interface, including at least one first processor, at least one controlled device in communication with the at least one first processor, wherein the at least one controlled device is a processor in communication with at least one media file and at least one application for managing or playing the at least one media file, at least one application running on the at least one first processor, wherein the at least one application is programmed to be automatically populated with media-related information associated with the at least one controlled device, and wherein the at least one application is further programmed to automatically generate at least one file that is configured for creation of at least one user interface that is based at least in part on the media-related information associated with the at least one controlled device.

The present disclosure also provides for a system for creating a user interface wherein the at least one user interface is a graphical user interface. The present disclosure also provides for a system for creating a user interface wherein the at least one media file is selected from the group consisting of digitally stored music, videos, movies, photographs, sound records, live video, camera images, graphics, album cover graphics and combinations thereof. The present disclosure also provides for a system for creating a user interface wherein the at least one file to create the at least one user interface is a configuration file.

The present disclosure also provides for a system for creating a user interface wherein the at least one user interface is installed and displayed on the at least one first processor, and wherein the at least one first processor interfaces through at least one application program interface associated with the at least one controlled device to automatically populate the at least one user interface with media-related information associated with the at least one media file to allow a user to utilize the at least one user interface to control the at least one media file.

The present disclosure also provides for a system for creating a user interface further including at least one second processor, wherein the at least one file to create the at least one user interface is transferred from the at least one first processor to the at least one second processor, wherein the at least one user interface is installed and displayed on the at least one second processor, and wherein the at least one second processor interfaces through at least one application program interface associated with the at least one controlled device to automatically populate the at least one user interface with media-related information associated with the at least one media file to allow a user to utilize the at least one user interface to control the at least one media file.

The present disclosure also provides for a system for creating a user interface wherein the at least one second processor is a touchscreen processor.

The present disclosure also provides for a system for creating a user interface wherein the at least one file to create the at least one user interface is transferred from the at least one first processor to the at least one controlled device, wherein the at least one user interface is installed and displayed on the at least one controlled device, and wherein the at least one controlled device interfaces through at least one application program interface associated with the at least one controlled device to automatically populate the at least one user interface with media-related information associated with the at least one media file to allow a user to utilize the at least one user interface to control the at least one media file.

The present disclosure also provides for a system for creating a user interface including at least one first processor, at least one controlled device in a control system, wherein the control system controls at least one controlled space and wherein the at least one controlled device is controlled by at least one control device, wherein the at least one controlled space includes at least one area, at least one controller capable of transmitting command signals to the at least one control device to change the status of the at least one controlled device, at least one application running on the at least one first processor, wherein the at least one application is programmed to allow a user to define a hierarchy representing the at least one controlled space, wherein the hierarchy defines a hierarchical relationship for the at least the at least one area, the at least one controlled device, and the at least one control device of the control system, and wherein the at least one application is further programmed to automatically generate at least one file that is configured for creation of at least one user interface that is based at least in part on the hierarchy representing the at least one controlled space.

The present disclosure also provides for a system for creating a user interface wherein the at least one user interface is installed and displayed on the at least one first processor, and wherein the at least one user interface is utilized by a user to send signals to the at least one controller or to the at least one control device to change the status of the at least one controlled device.

The present disclosure also provides for a system for creating a user interface wherein the at least one user interface is utilized by a user to send signals to the at least one controller or to the at least one control device to change the status of the at least one controlled device by manipulating a virtual control button or icon on the at least one user interface.

The present disclosure also provides for a system for creating a user interface further including at least one second processor, wherein the at least one file to create the at least one user interface is transferred from the at least one first processor to the at least one second processor, wherein the at least one user interface is installed and displayed on the at least one second processor, and wherein the at least one user interface is utilized by a user to send signals to the at least one controller or to the at least one control device to change the status of the at least one controlled device.

The present disclosure also provides for a system for creating a user interface wherein the at least one application is further programmed to allow a user to select or de-select at least the at least one area, the at least one controlled device, and the at least one control device and to automatically generate at least one file that is configured for creation of at least one user interface that is based at least in part on the user-selected hierarchy.

The present disclosure also provides for a system for creating a user interface wherein the hierarchy further includes at least one sub-area and at least one object, and wherein the at least one application allows a user to identify each at least one sub-area, each at least one object, each at least one control device, and each at least one controlled device associated with each at least one area.

The present disclosure also provides for a system for creating a user interface wherein the at least one controlled device is selected from the group consisting of electrical devices, loads, lights, lighting equipment, computers, processors, computing equipment, processing equipment, HVAC equipment, motors, shades, fans, outlets, security systems, electronics, electronic equipment, distributed audio systems, televisions, audio/video equipment and combinations thereof.

The present disclosure also provides for a method for creating a user interface including providing at least one first processor, providing at least one controlled device in a control system, wherein the control system controls at least one controlled space and wherein the at least one controlled device is controlled by at least one control device, wherein the at least one controlled space includes at least one area, providing at least one controller capable of transmitting command signals to the at least one control device to change the status of the at least one controlled device, running at least one application on the at least one first processor, wherein the at least one application is programmed to allow a user to define a hierarchy representing the at least one controlled space, wherein the hierarchy defines a hierarchical relationship for the at least the at least one area, the at least one controlled device, and the at least one control device of the control system, wherein the at least one application is further programmed to automatically generate at least one file that is configured for creation of at least one user interface that is based at least in part on the hierarchy representing the at least one controlled space, and generating at least one file that is configured for creation of at least one user interface that is based at least in part on the hierarchy representing the at least one controlled space.

The present disclosure also provides for a system for creating a user interface including at least one first processor, at least one controlled device in communication with the at least one first processor, wherein the at least one controlled device is a processor in communication with at least one web server and wherein the at least one web server includes at least one data file, at least one application running on the at least one first processor, wherein the at least one application is programmed to be automatically populated with web-based information associated with the at least one controlled device, and wherein the at least one application is further programmed to automatically generate at least one file that is configured for creation of at least one user interface that is based at least in part on the web-based information associated with the at least one controlled device.

The present disclosure also provides for a system for creating a user interface wherein the at least one data file is selected from the group consisting of HTML files, flash files, java applets, .xml files, text files, binary files and combinations thereof.

The present disclosure also provides for a system for creating a user interface wherein the at least one user interface is installed and displayed on the at least one first processor, and wherein the at least one user interface is utilized by a user to utilize data associated with the at least one data file. The present disclosure also provides for a system for creating a user interface wherein the at least one user interface is utilized by a user to utilize data associated with the at least one data file to interact with the at least one web server.

The present disclosure also provides for a system for creating a user interface further including at least one second processor, wherein the at least one file to create the at least one user interface is transferred from the at least one first processor to the at least one second processor, wherein the at least one user interface is installed and displayed on the at least one second processor, and wherein the at least one user interface is utilized by a user to utilize data associated with the at least one data file, or to interact with the at least one web server.

The present disclosure also provides for a system for creating a user interface wherein the at least one file to create the at least one user interface is transferred from the at least one first processor to the at least one controlled device, wherein the at least one user interface is installed and displayed on the at least one controlled device, and wherein the at least one user interface is utilized by a user to utilize data associated with the at least one data file, or to interact with the at least one web server.

Additional advantageous features, functions and applications of the disclosed systems and methods of the present disclosure will be apparent from the description which follows, particularly when read in conjunction with the appended figures.

### BRIEF DESCRIPTION OF THE DRAWINGS

To assist those of ordinary skill in the art in making and using the disclosed systems and methods, reference is made to the appended figures, wherein:

FIG. 1 is a schematic of an embodiment of a first processor, a second processor and a master controller according to the present disclosure;

FIG. 2 is a schematic of an embodiment of a central processor according to the present disclosure;

FIG. 3 is a schematic of an embodiment of a control or automation system according to the present disclosure;

FIG. 4 is a schematic of another embodiment of a control or automation system according to the present disclosure;

FIG. 5 is a schematic of exemplary embodiments of processors according to the present disclosure;

FIG. 6A is a screen shot of an embodiment of a GUI according to the present disclosure;

FIG. 6B is a screen shot of an embodiment of a GUI according to the present disclosure;

FIG. 6C is a screen shot of an embodiment of a GUI according to the present disclosure;

FIG. 6D is a screen shot of an embodiment of a GUI according to the present disclosure;

FIG. 6E is a screen shot of an embodiment of a GUI according to the present disclosure;

FIG. 6F is a screen shot of an embodiment of a GUI according to the present disclosure;

FIG. 6G is a screen shot of an embodiment of a GUI according to the present disclosure;

FIG. 6H is a screen shot of an embodiment of a GUI according to the present disclosure;

FIG. 6I is a screen shot of an embodiment of a GUI according to the present disclosure;

FIG. 6J is a screen shot of an embodiment of a GUI according to the present disclosure;

FIG. 6K is a screen shot of an embodiment of a GUI according to the present disclosure;

FIG. 6L is a screen shot of an embodiment of a GUI according to the present disclosure;

FIG. 6M is a screen shot of an embodiment of a GUI according to the present disclosure;

FIG. 6N is a screen shot of an embodiment of a GUI according to the present disclosure; and

FIG. 6O is a screen shot of an embodiment of a GUI according to the present disclosure.

### DETAILED DESCRIPTION

The present disclosure provides for systems and methods for facilitating the design, creation and/or implementation of a user interface for processor programs. In an exemplary embodiment, the present disclosure provides for systems and methods for creating at least one user interface for processor programs for controlling devices and/or for controlling (e.g., managing or playing) or utilizing media or data files. In one embodiment, the present disclosure provides for systems and methods for creating at least one user interface for control systems or automation systems or the like. In an exemplary embodiment, the at least one user interface includes at least one graphical user interface (“GUI”). The present disclosure also provides for systems and methods for synchronizing multiple processor applications utilizing the same services.

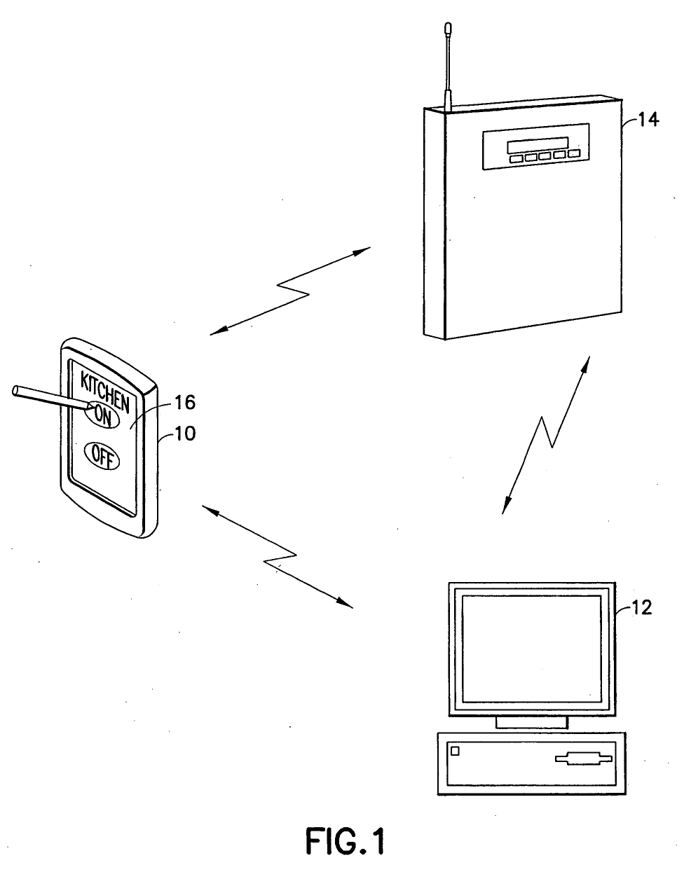

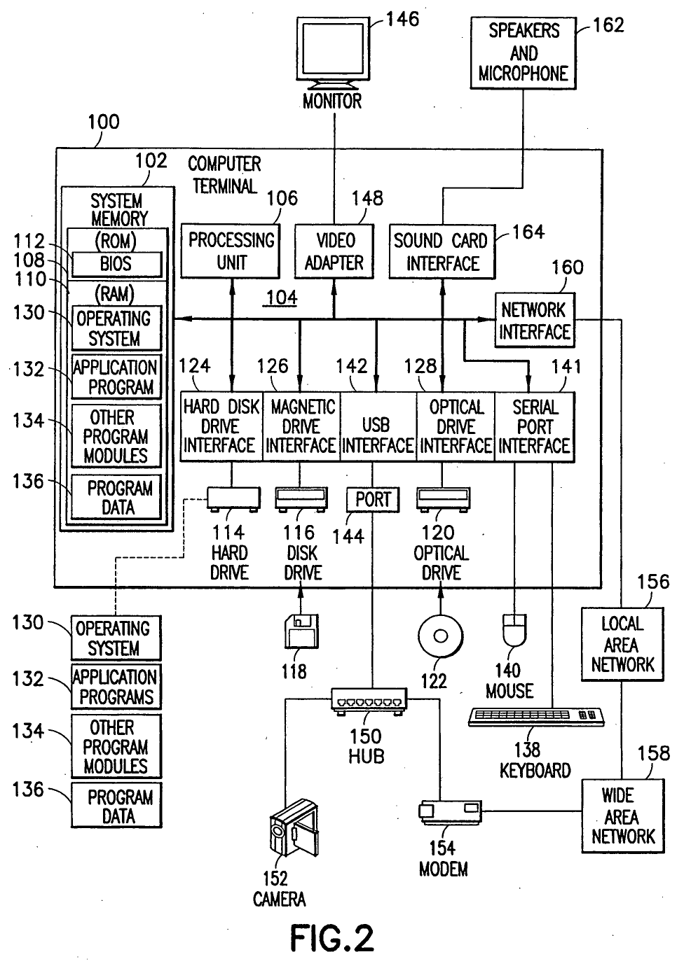

Referring now to the drawings, in one embodiment and as shown in FIG. 1, a first processor 10, a second processor 12, and a master controller 14 are shown. The details of first processor 10 and second processor 12 are more fully described in relation to FIG. 2 but will be briefly described here. For example, first processor 10 may be a touch screen computer, such as, but not limited to, a tablet having a display 16. In an exemplary embodiment, at least one user interface is shown on display 16 of first processor 10 for controlling devices and/or for controlling (e.g., managing or playing) or utilizing media or data files or the like on second processor 12. In an exemplary embodiment, first processor 10 and second processor 12 are used in a control system or automation system or the like, such as, for example, a home automation system, a commercial automation system, or other system. In one embodiment, the at least one user interface shown on display 16 is a graphical user interface (“GUI”).

In an exemplary embodiment, display 16 is touch sensitive, such that a user may control the devices by touching the buttons or icons on the screen of first processor 10. Examples of a suitable first processor 10 include, but is not limited to, a TPT 1210, TPT 700, TPT 650 or TPT 1040, all of which are manufactured by Vantage Controls, Inc., located in Orem, Utah. In another embodiment, first processor 10 may be connected to, for example, a TV, monitor or other display device having an IR/RF remote or the like.

In one embodiment, second processor 12 is a media server application or a personal computer (“PC”) running an application for managing and/or playing media files. For example, second processor 12 may be a dedicated media server running Windows® Media Center, a software program for managing and/or playing media files or the like. In an alternative embodiment, second processor 12 may be running a media player such as, for example, Windows® Media Player 10. In another alternative embodiment, second processor 12 may be a gaming console with media file managing and/or playing capabilities, such as, for example, an Xbox®. In another embodiment, second processor 12 may be a combination media player server and may include another service for playing media files or the like. In another alternative embodiment, second processor 12 may be a hand-held device such as, for example, a cell phone, mp3 player, an iPOD®, or the like.

In another embodiment, second processor 12 includes a web server. In one embodiment, the web server is a computer that stores Web documents and/or information and makes them available to the rest of the world over the World Wide Web. In another embodiment, the web server may be a web service. The web server may be dedicated, meaning that its purpose is to be a Web server, or non-dedicated, meaning it can be used for basic computing in addition to acting as a server. In an exemplary embodiment, second processor 12 is in communication with a web server, and the web server includes at least one data file. Examples of suitable data files include, but are not limited to, HTML files, flash files, java applets, .xml files, text files and/or binary files or the like.

In an exemplary embodiment, second processor 12 may be connected to a variety of devices through which media files managed by second processor 12 may be played. For example, second processor 12 may be connected to an audio system, a multi-zone audio system, a home theater system, a television, and/or a speaker system or the like. In an exemplary embodiment, stored in a database associated with second processor 12 are media files. Examples of suitable media files include, but is not limited to, digitally stored music, videos, movies, photographs, sound records, live video, camera images, graphics in a wide variety of file formats, and/or album cover graphics or the like. The media server and/or media player applications running on second processor 12 allow the media files to be managed and/or played. In one embodiment, user defined playlists may be stored in a memory location accessible by second processor 12. The media server and/or media player applications may include their own user interface, such as a GUI, for allowing a user to utilize the features of the media server and/or media player applications. However, users sometimes desire their own customized user interface for interfacing with the media server and/or media player applications from a remote location, such as from first processor 10. In an exemplary embodiment, the present disclosure provides for systems and methods for creating at least one customized user interface for remote devices (e.g., first processor 10) that have the ability to interface with the media server and/or media player applications from remote locations. Systems and methods for creating customized user interfaces for remote devices pursuant to the present disclosure will be described hereinafter. In an alternative embodiment, the present disclosure provides for systems and methods for creating at least one customized user interface for a processor running an application for managing and/or playing media files (e.g., second processor 12).

In one embodiment of the present disclosure, the media server and/or media player applications residing on second processor 12 may be accessed through published application program interfaces (“API”) specific to the applications. In general, an API is any interface that enables one program to use facilities provided by another, for example, by calling that program, or by being called by it. Thus, other applications may call upon the media server and/or media player on second processor 12 to, for example, play a media file stored on second processor 12. In an exemplary embodiment of the present disclosure, first processor 10, by using the appropriate API, can call the media server and/or media player residing on second processor 12 to play a media file. It will be appreciated that the API allows processor 10 to display a customized user interface, i.e., a non-native interface with respect to the media server and/or media player residing on second processor 12. In an exemplary embodiment, first processor 10 communicates with the media server and/or media player residing on second processor 12 using the API protocol. In an exemplary embodiment, first processor 10 displays at least one user interface, such as a GUI, on its display 16 for allowing the control of media files residing on second processor 12 by interfacing through an API with a media server and/or media player on second processor 12. In an alternative embodiment, second processor 12 displays at least one customized user interface, such as a GUI, for allowing the control of media files residing on second processor 12 by interfacing through an API with a media server and/or media player on second processor 12.

In one embodiment, a user of the first processor 10 may, for example, play a playlist of music residing on second processor 12 through at least one customized user interface on display 16 of first processor 10. Two-way communication may be provided between first processor 10 and second processor 12. For example, first processor 10 may communicate with second processor 12 via wireless or wired connections. Second processor 12 may communicate with first processor 10 to provide information about the media files residing on second processor 12. For example, if through the at least one user interface displayed on first processor 10 the user selects a “classical music” button or icon, a listing of all media files containing classical music accessible by second processor 12 is transmitted to first processor 10. The listing may, for example, include the song title, the composer, the album, the album cover art, or any other information stored on processor 12. In addition, first processor 10 may display information on play queues, and information about current media files being played, e.g., what media file is being played. Thus, it will be appreciated that two-way communication between first processor 10 and second processor 12 allows any information available locally on second processor 12 to be displayed on the at least one user interface of first processor 10. Information about the media files stored on second processor 12 may auto-populate the at least one user interface on first processor 10 when called. First processor 10 and second processor 12 may communicate directly, or may communicate indirectly via controller 14. In one embodiment, through the use of first processor 10, the second processor 12, running a media server and/or a media player application, becomes a media source instead of a central controller for the media files. In an alternative embodiment, the at least one customized user interface is run on second processor 12, and information about the media files stored on second processor 12 may auto-populate the at least one customized user interface on second processor 12 when called.

In an exemplary embodiment, second processor 12 may be running a media player (e.g., Windows® Media Player 10), and may also include another application (e.g., iTunes®) for playing media files. In one embodiment, second processor 12 may be running a media player and may also be running iTunes®R, wherein the media player and iTunes® are each controlled by an identical API. In an exemplary embodiment, the API for both the media player and iTunes® may be, for example, a network API using TCP/IP. Thus, first processor 10 may communicate with the media player and iTunes® running on second processor 12 using an identical API protocol (e.g., a network API using TCP/IP). In an exemplary embodiment, first processor 10 displays at least one user interface on its display 16 for allowing the control of media files residing on second processor 12 by interfacing through an API with a media server and iTunes® residing on second processor 12.

In another embodiment, second processor 12 is in communication with a web server, and the web server includes at least one data file. The web server may be running at least one application for utilizing the at least one data file. The web server application may include its own user interface, such as a GUI, for allowing a user to utilize the features of the web server application. However, users sometimes desire their own customized user interface for interfacing with the web server applications from a remote location such as from first processor 10, for example. In an exemplary embodiment, the present disclosure provides for systems and methods for creating at least one customized user interface for remote devices that have the ability to interface or interact with the web server applications from remote locations. In an alternative embodiment, the present disclosure provides for systems and methods for creating at least one customized user interface for a processor running an application for utilizing the at least one data file, or to interface or interact with the web server applications.

In an exemplary embodiment, first processor 10 displays at least one customized user interface, such as a GUI, on its display for allowing the utilization of data associated with the at least one data file provided by the web server. In an alternative embodiment, second processor 12 displays at least one customized user interface for allowing the utilization of data associated with the at least one data file provided by the web server. Second processor 12 may communicate with first processor 10 to provide information or data associated with the at least one data file provided by the web server. Thus, it will be appreciated that two-way communication between first processor 10 and second processor 12 allows any information or data available locally on second processor 12 to be displayed on the at least one user interface of first processor 10. Information or data associated with the at least one data file provided by the web server may auto-populate the at least one user interface on first processor 10 when called. A user may then utilize the at least one user interface to utilize the information or data associated with the at least one data file provided by the web server. In one embodiment, a user utilizes the at least one user interface to utilize the information or data associated with the at least one data file provided by the web server to interact with the at least one web server.

In an alternative embodiment, the at least one customized user interface is run on second processor 12, and information or data associated with the at least one data file provided by the web server may auto-populate the at least one customized user interface on second processor 12 when called. A user may then utilize the at least one user interface to utilize the information or data associated with the at least one data file provided by the web server. In one embodiment, a user utilizes the at least one user interface to utilize the information or data associated with the at least one data file provided by the web server to interact with the at least one web server.

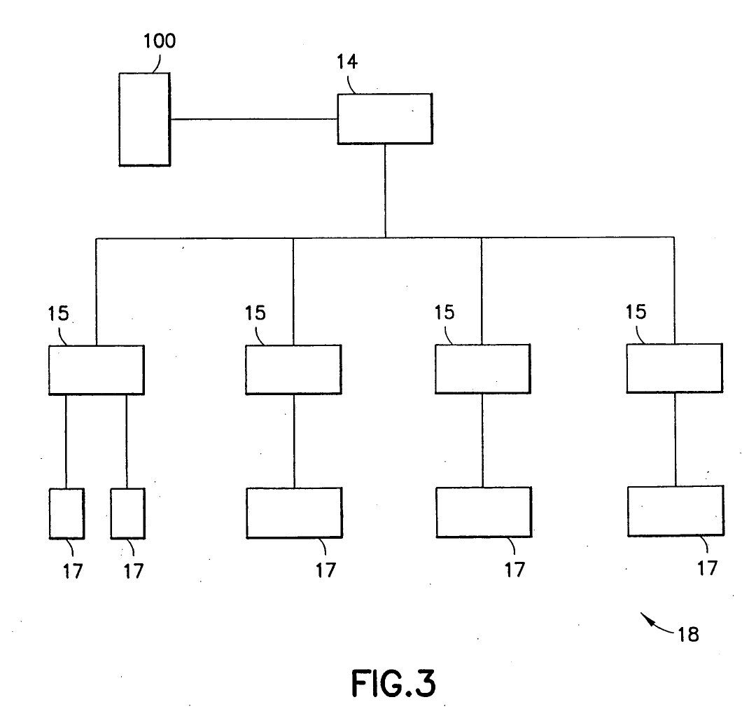

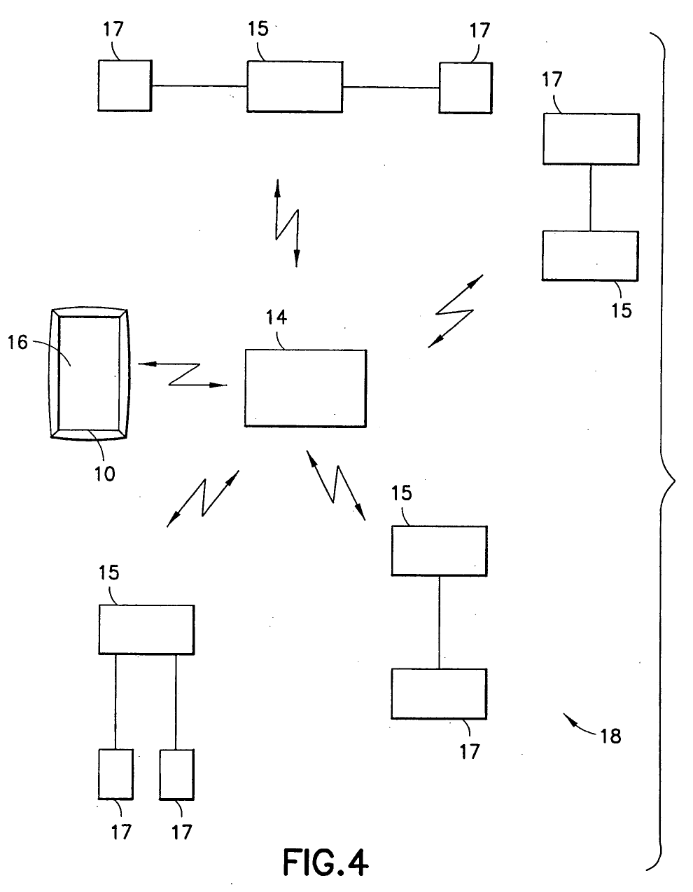

In an exemplary embodiment of the present disclosure and as depicted in FIGS. 1, 3 and 4, master controller 14 is a controller for a control or automation system 18. Examples of suitable control or automation systems include, without limitation, a home automation system, a commercial automation system, or other system or the like. The master controller 14 may communicate directly with either first processor 10 or with second processor 12. As shown in FIGS. 3 and 4, the control or automation system 18 may include, inter alia, control devices 15. Examples of suitable control devices 15 include, without limitation, electrical control devices, lighting controls, modules, dimmers, relays, HVAC controls, motor controls, window treatment controls, security controls, temperature controls, water feature controls, media controls and/or audio/video controls or the like. For example, the master controller 14 may be the main central processing unit (“CPU”) of the control or automation system 18, or it may be an access point to the automation system network. Exemplary control or automation systems 18 of the present disclosure are illustrated in FIGS. 3 and 4.

In an exemplary embodiment and as shown in FIGS. 3 and 4, the master controller 14 may transmit command signals to control devices 15 to change the status of a controlled device 17 (e.g., to turn a light on or off). Examples of suitable controlled devices 17 include, without limitation, electrical devices, loads, lights, lighting equipment, computers, processors, processing equipment, computing equipment, HVAC equipment, motors, shades, fans, outlets, security systems, electronics, electronic equipment, distributed audio systems, televisions and/or audio/video equipment or the like. The master controller 14 may receive status signals from the control devices 15 regarding the status of a controlled device 17. In an exemplary embodiment, a control device 15 includes a controllably conductive device, such as, for example, a relay or triac, to control power to a controlled device 17. In exemplary embodiments, control devices 15 may be wall-box mounted or enclosure mounted. The control devices 15 may include control points, or the control points may be separate, such as, for example, a keypad.

As mentioned, a control device 15 may include a control point. A control point may include one or more manual actuators for local control of the controlled device 17. Examples of a control device 15 having a control point include, but is not limited to, a RadioLink ScenePoint™ Dimmer Station or a ScenePoint™ Dimmer Station, each manufactured by Vantage Controls, Inc. in Orem, Utah.

Each manual actuator on the control points of a control device 15 may be programmed to control a “scene.” Thus, a single manual actuator may control multiple controlled devices 17 or loads. The scene information may be stored on the master controller 14. Thus, in an exemplary embodiment, when an actuator is actuated, the actuation is reported to the master controller 14. The controller 14 then implements the scene pursuant to programming residing on the master controller 14. The controller 14 may transmit a series of command signals to various control devices 15.

Referring back to FIG. 1 and in an exemplary embodiment, first processor 10 displays at least one user interface, such as a GUI, on its display 16 for allowing the control of media files residing on second processor 12 by interfacing through an API with a media server and/or media player on second processor 12. In another embodiment and as shown in FIGS. 1, 3 and 4, the user interface on first processor 10 may also be used to control controlled devices 17 controlled by a control or automation system 18. The first processor 10 can send signals to the controller 14 to thereby change the status of controlled devices 17. Alternatively, the first processor 10 can send signals to the control devices 15 directly instead of the controller 14. As explained below, the first processor 10 can replicate any control point located on the control or automation system 18. Thus, in an exemplary embodiment, the master controller 14 reacts to the replication in the same manner that it would react to a signal from a control point itself For example, an actuator on a control point (e.g., a keypad) may be programmed with the following “scene”: (i) dim the lights in a home theater, and (ii) close the drapes. This programming could reside on the master controller 14. Thus, a user may actuate the actuator on the control point and (i) the lights in the home theater will dim, and (ii) the drapes will close. To accomplish this task, in one embodiment of the present disclosure, the control point sends a signal to the controller 14 reporting that the actuator has been pressed and this report causes the controller 14 to execute the programming to (i) dim the lights, and (ii) close the drapes. For example, this may involve sending signals to the appropriate dimmer connected to the lights and drape motor control devices.

In an alternative embodiment, the first processor 10 can be used to replicate the same functionality as the actuator on the control point via a virtual control button or icon on the at least one user interface on first processor 10. The virtual control can be implemented in such a manner to cause the controller 14 to carry out the same “scene” as if the actual actuator on the control point had been actuated by a user. Thus, the programming associated with an actuator on a control point can also be executed via the at least one user interface on first processor 10. In other words, the controller 14 will carry out the assigned programming associated with an actuator if the actuator is actually pressed by a user, or if the user manipulates a virtual control button or icon on a user interface on first processor 10. For this reason, the first processor 10 is said to replicate the control points. In another embodiment of the present disclosure, the at least one customized user interface is running on second processor 12, and the programming associated with an actuator on a control point may be executed via the at least one user interface on second processor 12.

In one embodiment of the present disclosure and as depicted in FIG. 2, a central processor 100 is shown that may be used for controlling devices and/or for controlling (e.g., managing or playing) or utilizing media or data files or the like. In an exemplary embodiment, the present disclosure provides for systems and methods for defining at least one user interface for central processor 100 for controlling devices and/or for controlling (e.g., managing or playing) or utilizing media or data files. Central processor 100 may be used, for example, in a control system or automation system or the like. In one embodiment, central processor 100 may be used instead of the processing devices shown in FIG. 1, namely, instead of the first processor 10, second processor 12 and controller 14.

It will be appreciated that the processing devices shown in FIG. 1 may have more or fewer features than shown in FIG. 2 as the individual circumstances require. Further, the processing devices shown in FIG. 1 may have various form factors, such as, for example, a desktop PC, a portable tablet form, a hand-held form, wall-mount, etc. The features shown in FIG. 2 may be integrated or separable from the central processor 100. For example, while the monitor 146 is depicted in FIG. 2 as being separate, monitor 146 may be integrated into the central processor 100, such as when central processor 100 is a tablet type computer.

In an exemplary embodiment, the central processor 100 includes a system memory 102, and a system bus 104 that interconnects various system components including the system memory 102 to the processing unit 106. The system bus 104 may be any of several types of bus structures, including, but not limited to, a memory bus or memory controller, a peripheral bus, or a local bus using any of a variety of bus architectures as is known to those skilled in the relevant art. The system memory 102 may include read only memory (ROM) 108 and random access memory (RAM) 110. A basic input/output system (BIOS) 112, containing the basic routines that help to transfer information between elements within the central processor 100, such as during start-up, is stored in ROM 108. The central processor 100 may further include a hard disk drive 114 for reading and writing information to a hard disk (not shown), a magnetic disk drive 116 for reading from or writing to a removable magnetic disk 118, and/or an optical disk drive 120 for reading from or writing to a removable optical disk 122 such as a CD-ROM, DVD, or other optical media or the like.

The hard disk drive 114, magnetic disk drive 116, and optical disk drive 120 may be connected to the system bus 104 by a hard disk drive interface 124, a magnetic disk drive interface 126, and an optical disk drive interface 128, respectively. The drives and their associated processor-readable media provide non-volatile storage of processor-readable instructions, data structures, program modules and other data for the central processor 100. Although the exemplary operating environment described herein employs a hard disk, a removable magnetic disk 118, and/or a removable optical disk 122, it will be appreciated by those skilled in the relevant art that other types of processor-readable media which can store data that is accessible by a processor, such as, for example, magnetic cassettes, flash memory cards, digital video disks, Bernoulli cartridges, random access memories, read only memories, or the like may also be used in the exemplary operating environment.

A number of program modules may be stored on the hard disk, magnetic disk 118, optical disk 122, ROM 108 or RAM 110, including, but not limited to, an operating system 130, one or more applications programs 132, other program modules 134, and/or program data 136. A user may enter commands and information into the central processor 100 through input devices such as a keyboard 138 and a pointing device 140, such as a mouse. Other input devices (not shown) may include, without limitation, a joystick, game pad, satellite dish, scanner, or the like. These and other input devices may be connected to the processing unit 106 through a serial port interface 141 that is coupled to the system bus 104. Alternatively, such devices may be connected by the next generation of interfaces, such as, for example, a universal serial bus (USB) interface 142 with a USB port 144, and to which other hubs and devices may be connected. Other interfaces (not shown) that may be used include, without limitation, parallel ports, game ports, or the IEEE 1394 specification.

A monitor 146 or other type of display device may also be connected to the system bus 104 via an interface, such as, for example, a video adapter 148. In addition to the monitor 146, central processor 100 typically includes other peripheral output or input devices. Examples of other suitable peripheral output or input devices include, without limitation, an ultra slim XGA touch panel, or a resistive finger touch screen.

As depicted in FIG. 2, a USB hub 150 is shown connected to the USB port 144. The hub 150 may be connected to other devices such as, for example, a web camera 152 or modem 154. Examples of other suitable devices that may be connected to the hub 150 or USB port 144 include, without limitation, a keyboard, scanner, printer, external drives (e.g., hard, disk or optical), or a pointing device. Additional cameras and/or devices may be directly connected to the processor 100 through the USB port 144. Thus, the system depicted in FIG. 2 is capable of communicating with a network, and is capable of sending/receiving audio, video and/or data.

The central processor 100 may operate in a networked environment using logical connections to one or more remote processors (not shown). Examples of suitable types of connections between networked devices include, without limitation, dial-up modems, (e.g., modem 154 may be directly used to connect to another modem), ISDN, xDSL, cable modems, wireless, or connections spanning users connected to the Internet. The remote processor (not shown) networked to central processor 100 may be, for example, a computer, a personal computer, a server, a router, a network PC, a peer device or other common network node, and typically includes many or all of the elements described above in regards to the central processor 100 in FIG. 2. In one embodiment and as depicted in FIG. 2, the logical connections may include a local area network (LAN) 156 and/or a wide area network (WAN) 158. Such networking environments are utilized in, for example, offices, enterprise-wide computer networks, intranets and the Internet.

In one embodiment of the present disclosure, when the central processor 100 is used in a LAN networking environment, the processor 100 is connected to the local network 156 through a network interface or adapter 160. The processor 100 may also connect to the LAN via through any wireless communication standard, such as, for example, the 802.11 wireless standard. In another embodiment, when the central processor 100 is used in a WAN networking environment, the processor 100 typically uses modem 154 or other means for establishing communications over the wide area network 158. Modem 154 may be internal or external, and in one embodiment is connected to the system bus 104 through USB port 144. A modem may optionally be connected to system bus 104 through the serial port interface 141. It will be appreciated that the network connections shown are exemplary and other means of establishing a communications link between the processors may be used, e.g., from a LAN gateway to WAN.

The central processor 100 may also receive audio input from a microphone 162 and output audio sounds through speakers 162 as illustratively shown in FIG. 2. In one embodiment, a sound card interface 164 processes the sounds to a sound card and the system bus 104.

Central processor 100 may take many forms as is known to those having relevant skill in the art, including, without limitation, a computer, a desk top personal computer, a laptop computer, a hand-held computer, or the like. Further, the processor compatibility of the central processor 100 may include, without limitation, IBM PC/XT/AT, or compatibles, or Apple Macintosh. The operating system 130 compatibility may include, without limitation, MS-DOS, MS-Windows, Unix, or Macintosh.

Generally, the data processors of processor 100 are programmed by means of instructions stored at different times in the various processor-readable storage media of processor 100. Programs and operating systems are typically distributed, for example, on floppy disks or CD-ROMS, and from there they are typically installed or loaded into the secondary memory of processor 100. In an exemplary embodiment, the programs and operating systems are loaded at least partially into the processor's primary electronic memory at execution. The embodiments of the present disclosure described herein includes these and other various types of processor-readable storage media when such media contain instructions or programs for implementing the steps described herein in conjunction with a microprocessor or other data processor. The embodiments of the present disclosure also include the processor 100 itself when programmed according to the methods and techniques described herein.

In one embodiment, the central processor 100 may have loaded into memory a web browser, which in general is an application program that provides a way to look at and interact with information on the World Wide Web. Netscape and Microsoft Internet Explorer are examples of two types of browsers that may be used.

In one embodiment, the central processor 100 may include a web server. In an exemplary embodiment, the web server (not shown) may take substantially the same form as the central processor shown in FIG. 2. In one embodiment, the web server is a computer that stores Web documents and/or information and makes them available to the rest of the world over the World Wide Web. In another embodiment, the web server may be a web service. The web server may be dedicated, meaning that its purpose is to be a Web server, or non-dedicated, meaning it can be used for basic computing in addition to acting as a server. In an exemplary embodiment, central processor 100 is in communication with a web server, and the web server includes at least one data file. In one embodiment, the main body of software used with the present disclosure resides on the web server. Referring back to FIG. 1, the software may also reside on second processor 12.

The processor 100 may be directly connected to a power source, such as AC power, or comprise a battery for allowing portable operation. The processor 100 may also include other features not explicitly shown in FIG. 2, including expansion slots for adding additional hardware to the processor 100 and I/O ports which may include, without limitation, RJ-11 modems, RJ-45 fast Ethernet ports, USB ports, IEEE 1394 ports, headphone jack, microphone jack or a VGA port. Other examples of additional features of the processor 100 may include short-cut buttons, a wheel key, a power switch and a wireless LAN On/Off switch.

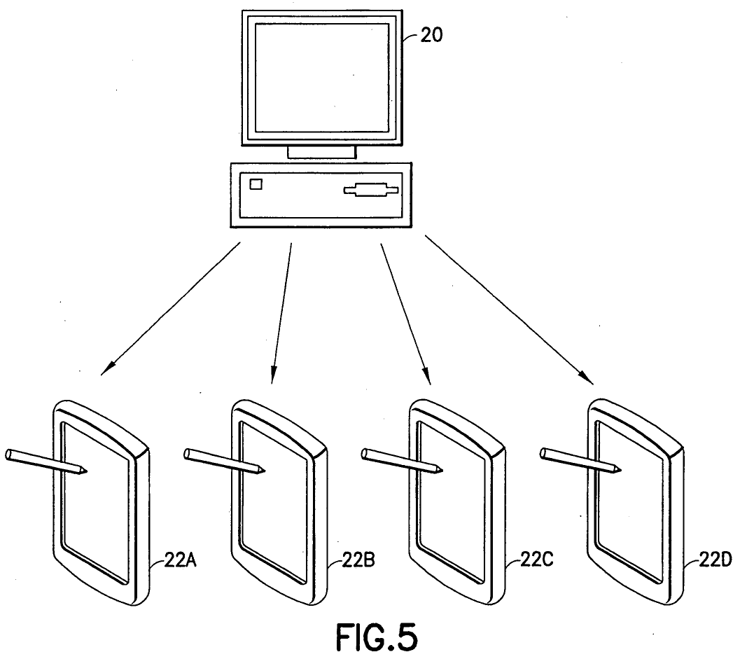

Referring now to FIG. 5, there is depicted an exemplary system for creating at least one user interface on processor 20 for use on processors 22A-22D for controlling devices and/or for controlling (e.g., managing or playing) or utilizing media or data files. In an exemplary embodiment, processor 20 and processors 22A-22D are used in a control system or automation system or the like, and the at least one user interface is a GUI. In exemplary embodiments, processors 22A-22D are similar to first processor 10 as depicted and described in relation to FIG. 1, and processor 20 may be of similar design as to second processor 12 as described in relation FIG. 1, or of similar design as to central processor 100 as described in relation to FIG. 2. In an another embodiment, processor 20 is primarily used to create the at least one user interface for use on processors 22A-22D for controlling devices and/or for controlling or utilizing media or data files.

In an exemplary embodiment, an application to facilitate the creation of at least one user interface is loaded on processor 20. Programs A and D in the computer program listing are exemplary programs capable of carrying out the features described herein. As described in detail below, the application provides novel features to assist a user in creating a user interface. In an exemplary embodiment, the application running on processor 20 simplifies the creation of the at least one user interface by allowing a user to create a hierarchy representing a “controlled space.” As used herein, the term “controlled space” means any space under the control of one or more automation or control systems or the like. For example, a controlled space may be as large as a campus or a complex of buildings. The controlled space may also be, for example, a building, a portion of a building, a residence, a floor, a single room, or a combination of rooms. A controlled space may include, for example, an outdoor area as well, such as a park, a street, a city, a base, a walkway, a zone, etc. There is no requirement that a controlled space include contiguous areas. The controlled space may include non-contiguous areas.

In an exemplary embodiment, once the hierarchy representing a controlled space has been created, the application of the present disclosure automatically populates the at least one user interface based upon the created hierarchy. The user can further select or de-select entries in the hierarchy to create additional user interfaces based upon each edited or modified hierarchy. Thus, once a hierarchy for the controlled space is created, an unlimited number of user interfaces may be created without the need for individual customization of each interface. This is a significant advantage over what was previously available.

In an exemplary embodiment, once created (e.g., on processor 20), the at least one user interface, in the form of one or more files, can be transferred to any or all of processors 22A-22D as shown in FIG. 5, where the at least one user interface can then be rendered and used for control purposes by a user. In an exemplary embodiment, the at least one user interface is used on any or all of processors 22A-22D for controlling devices and/or for controlling (e.g., managing or playing) or utilizing media or data files or the like. In an exemplary embodiment, the at least one user interface is a GUI.

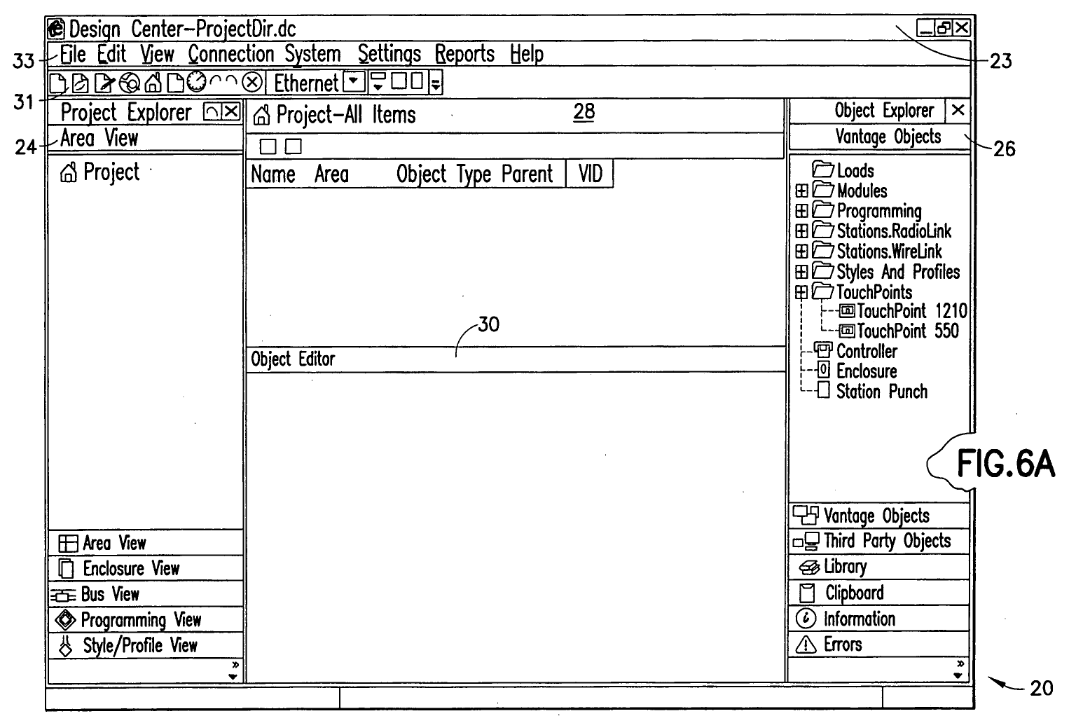

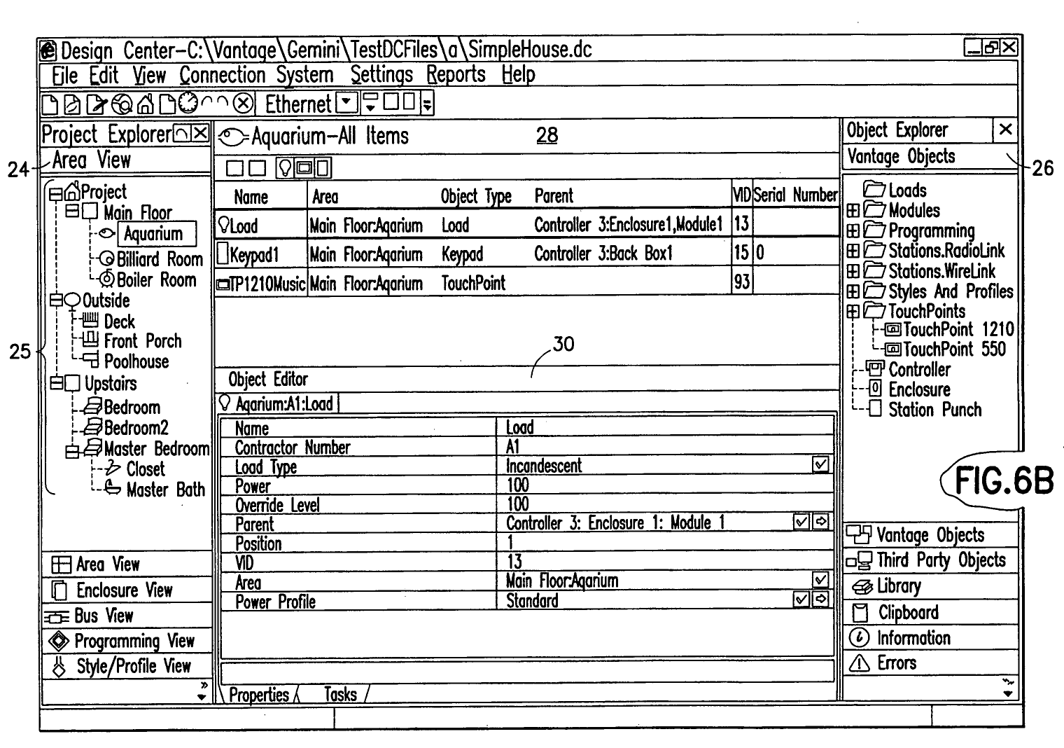

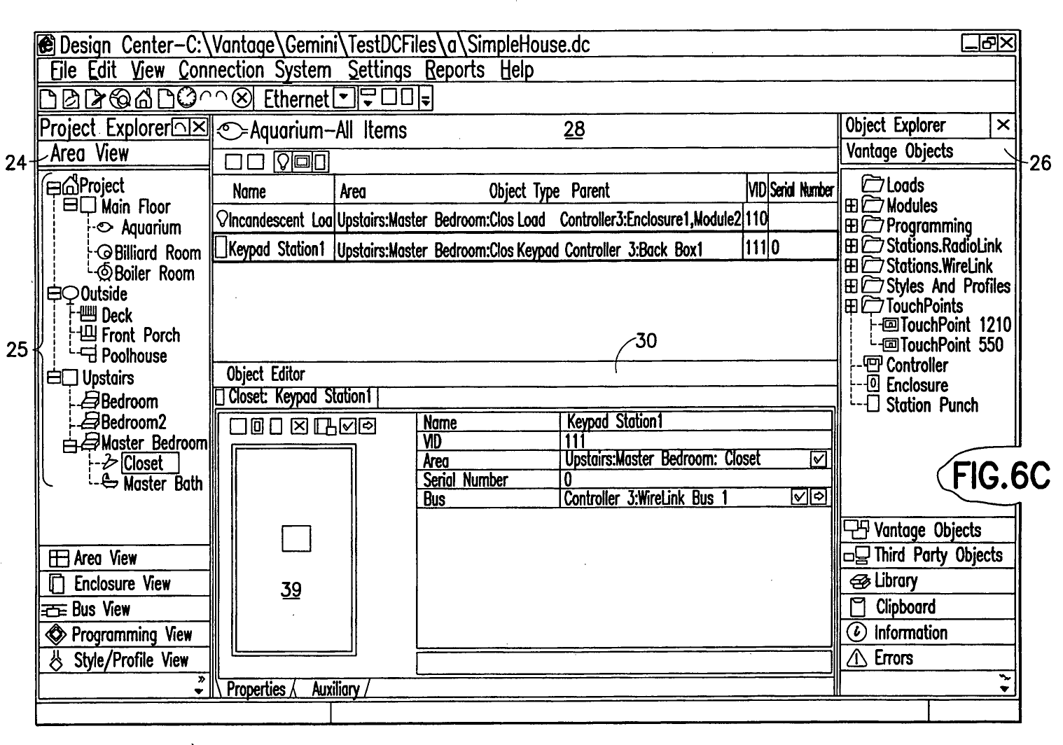

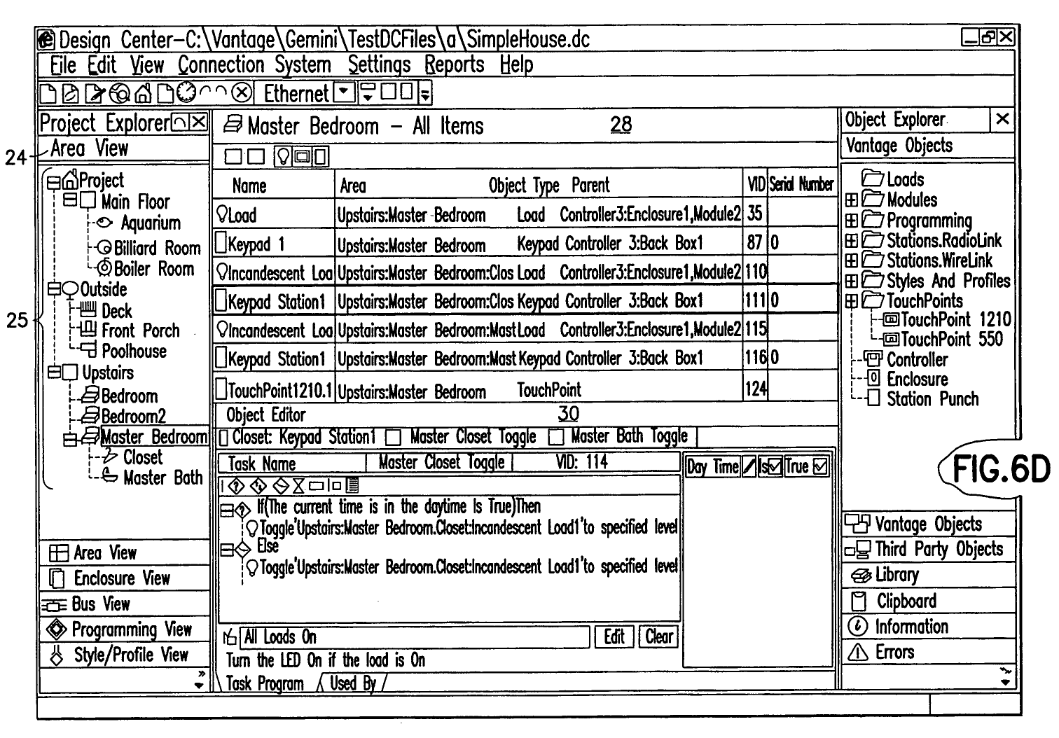

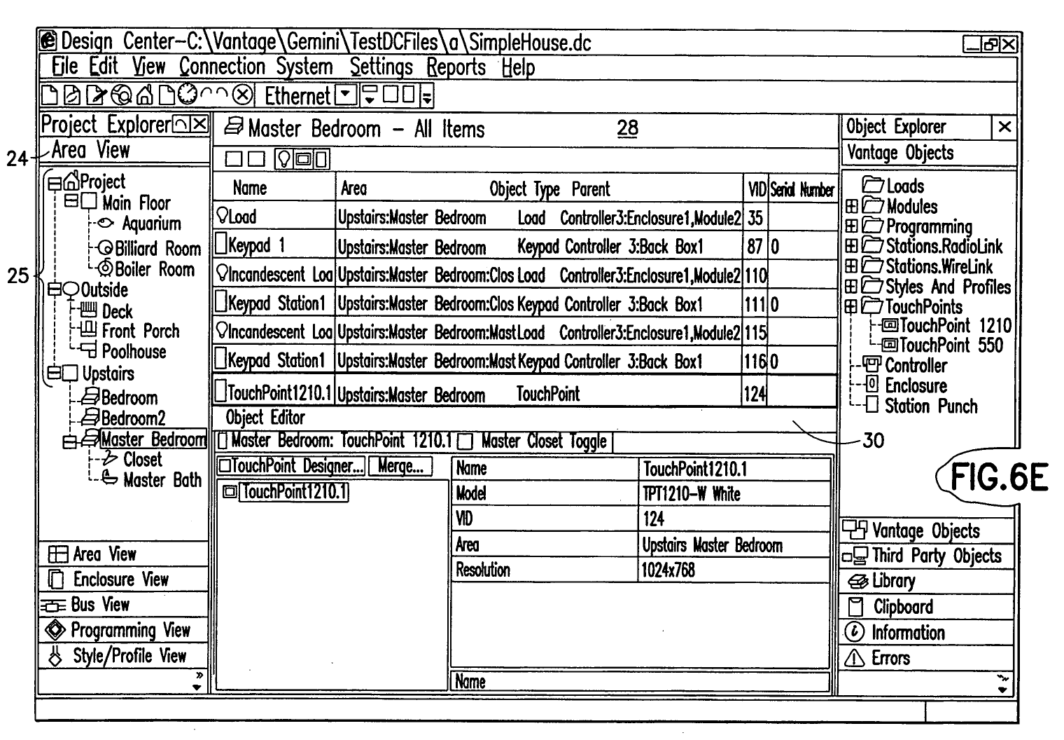

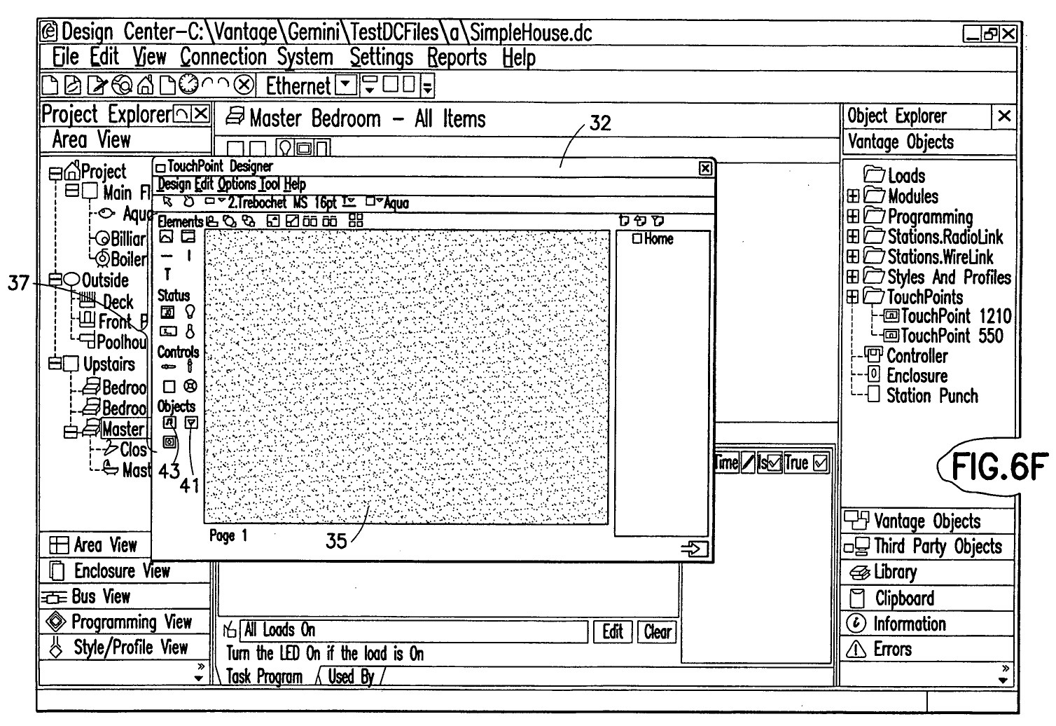

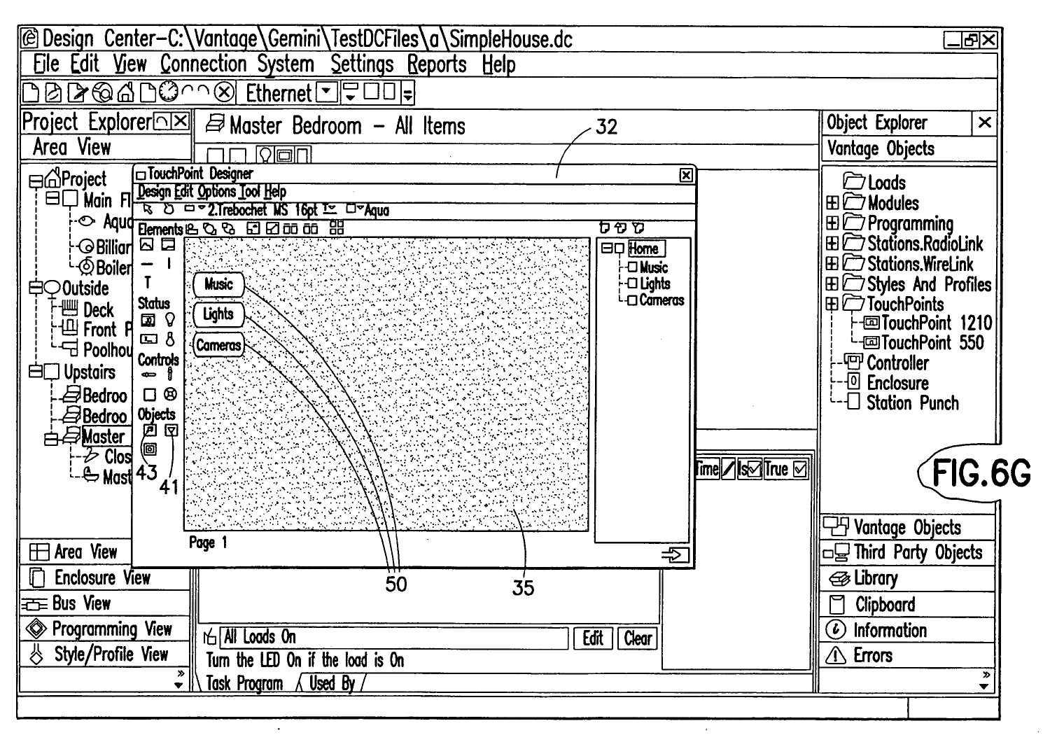

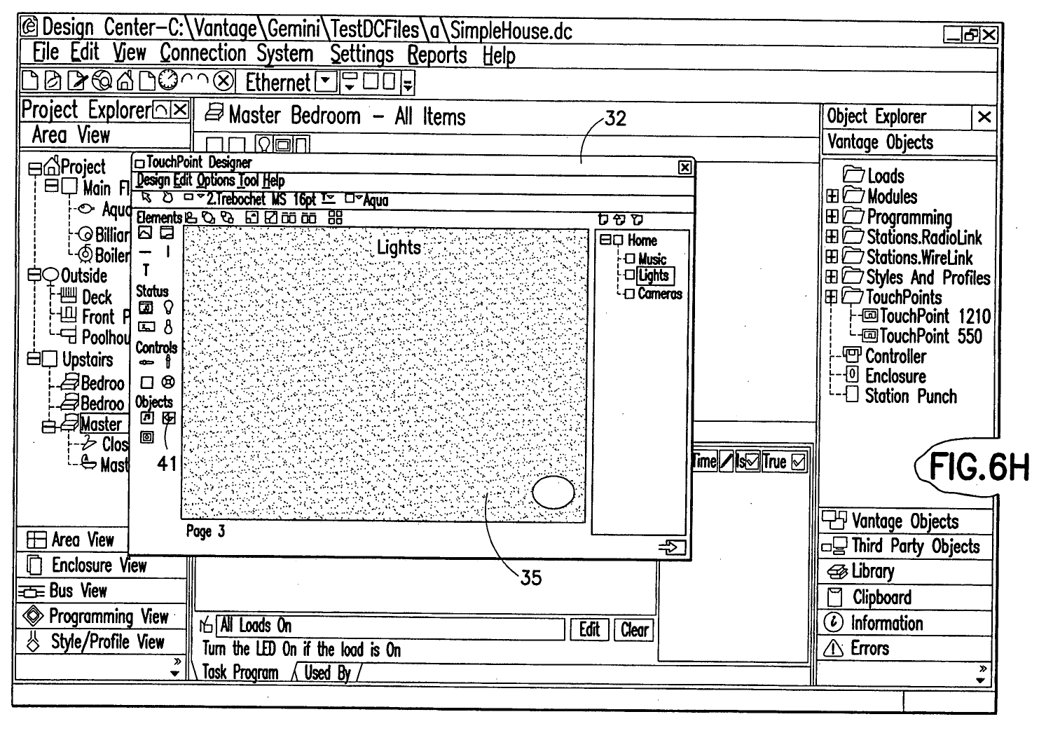

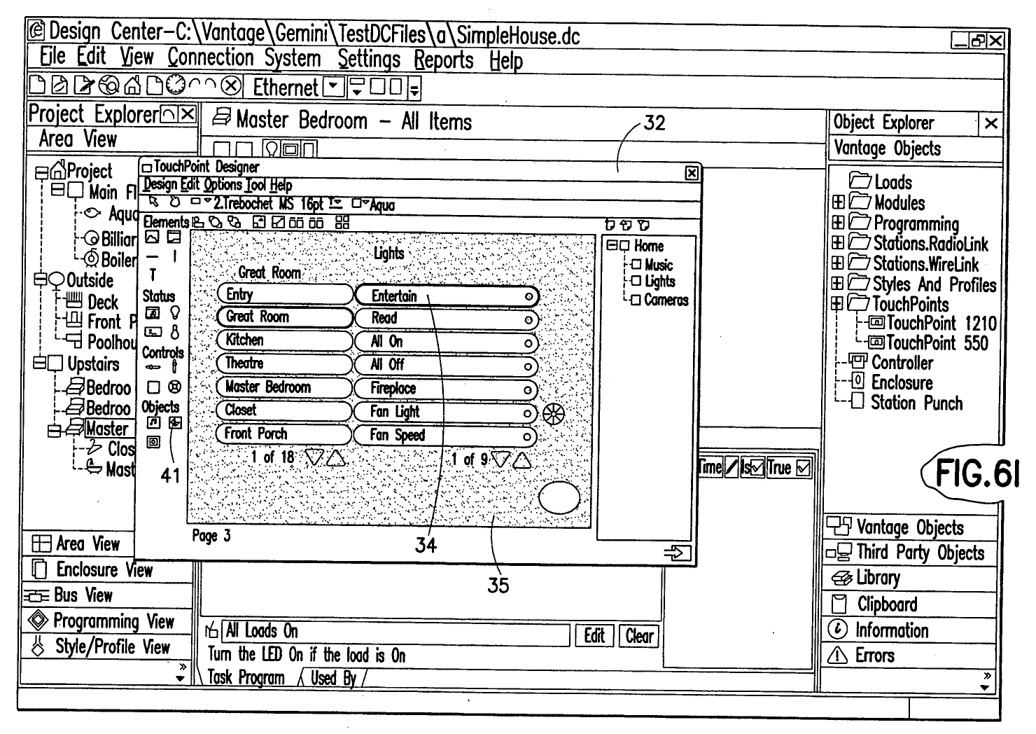

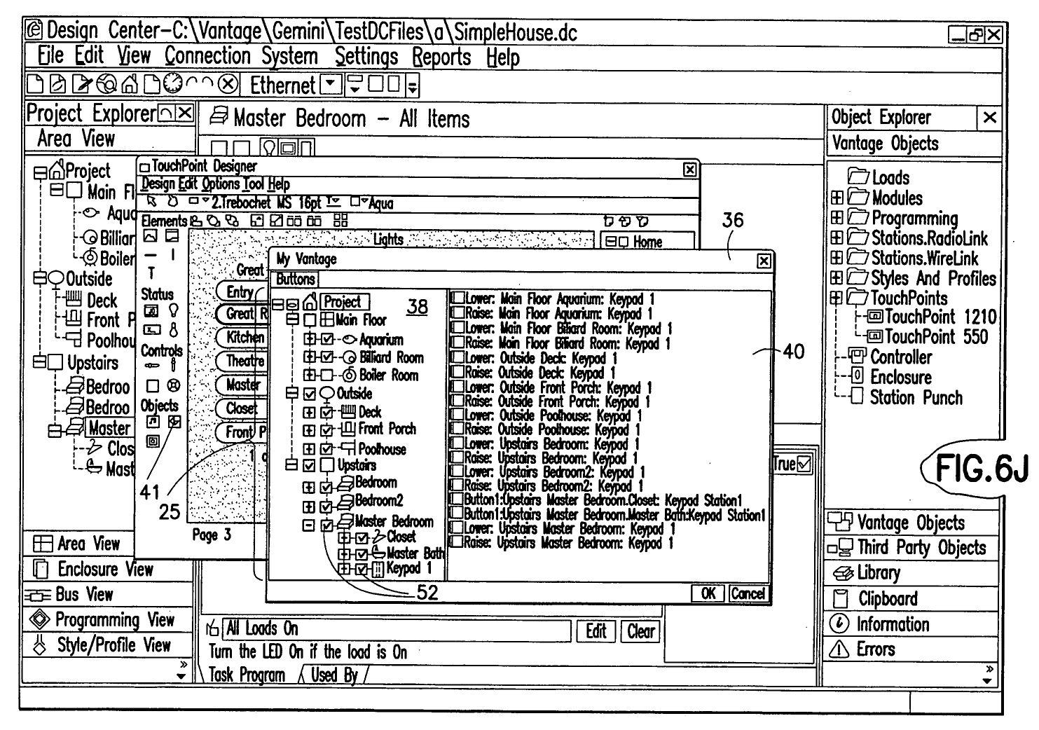

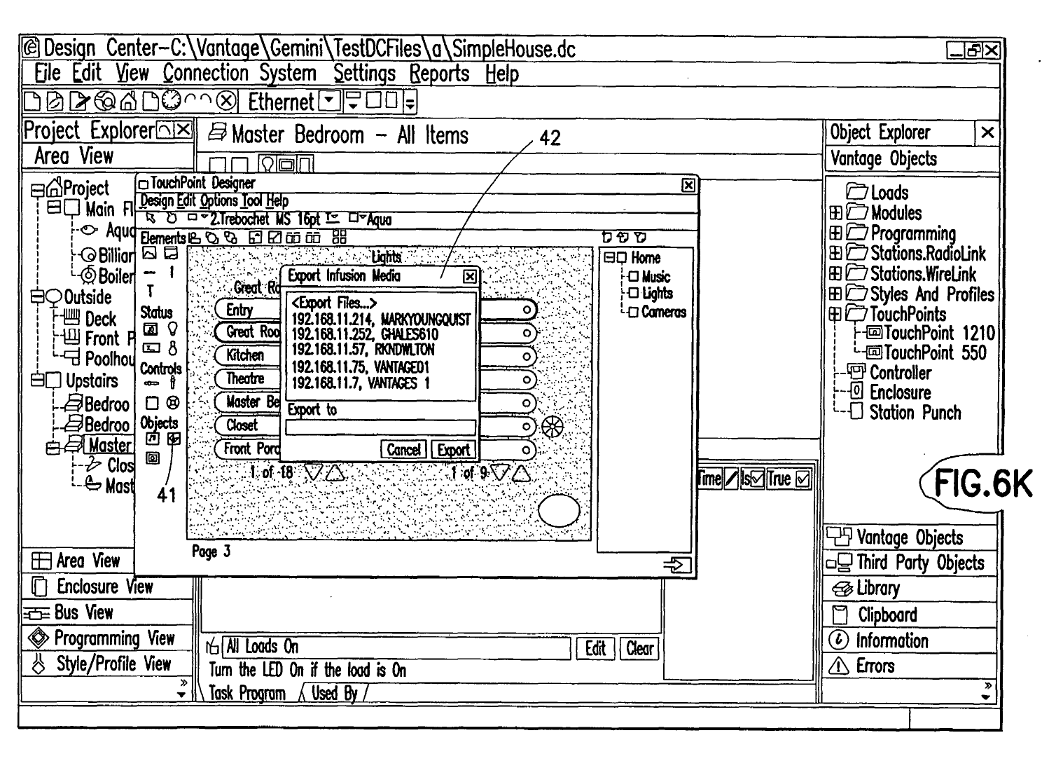

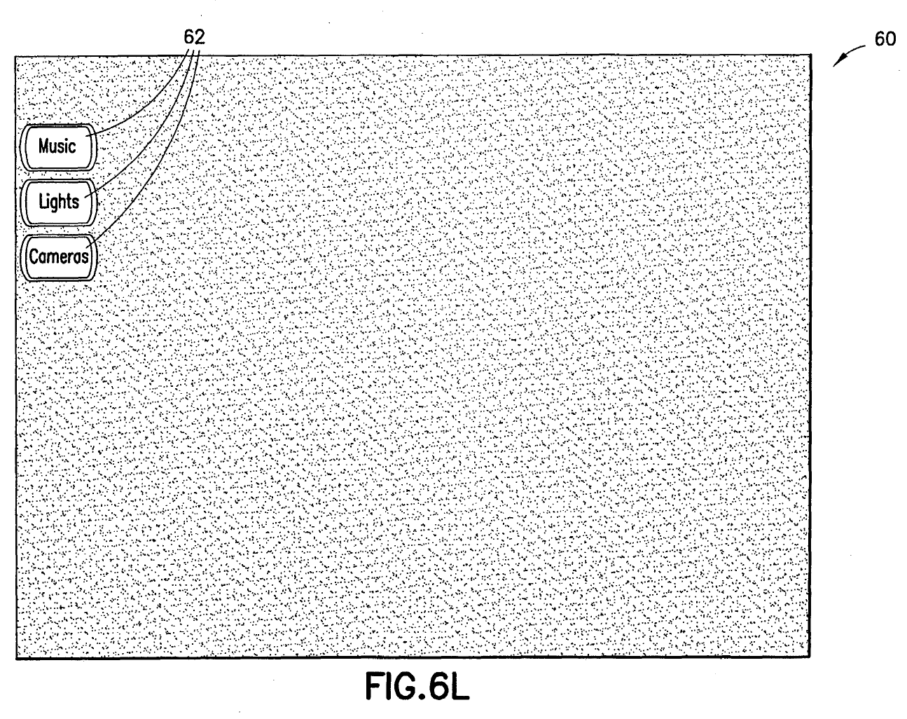

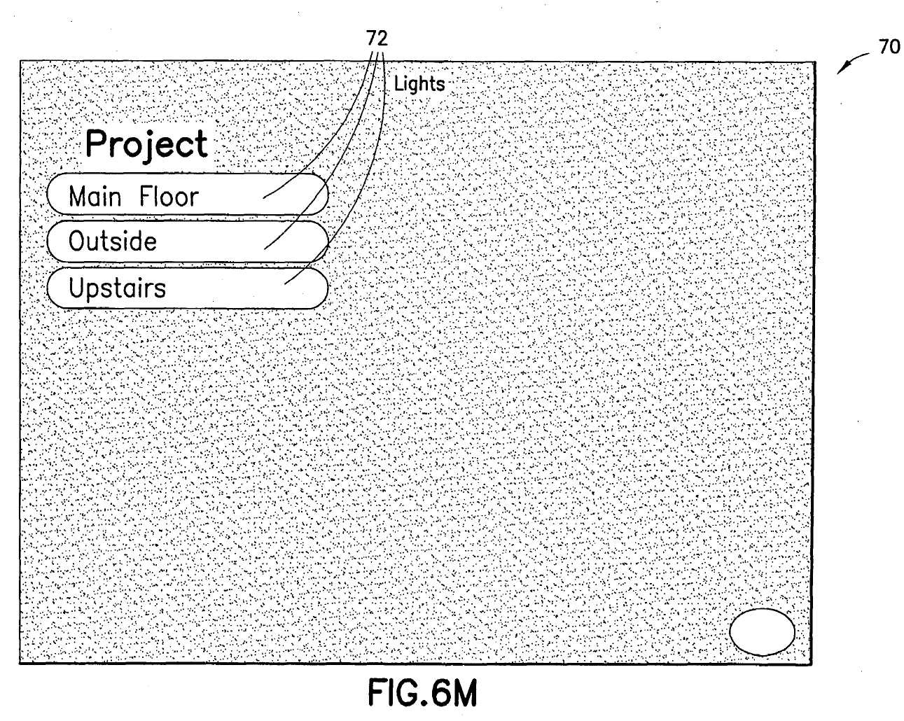

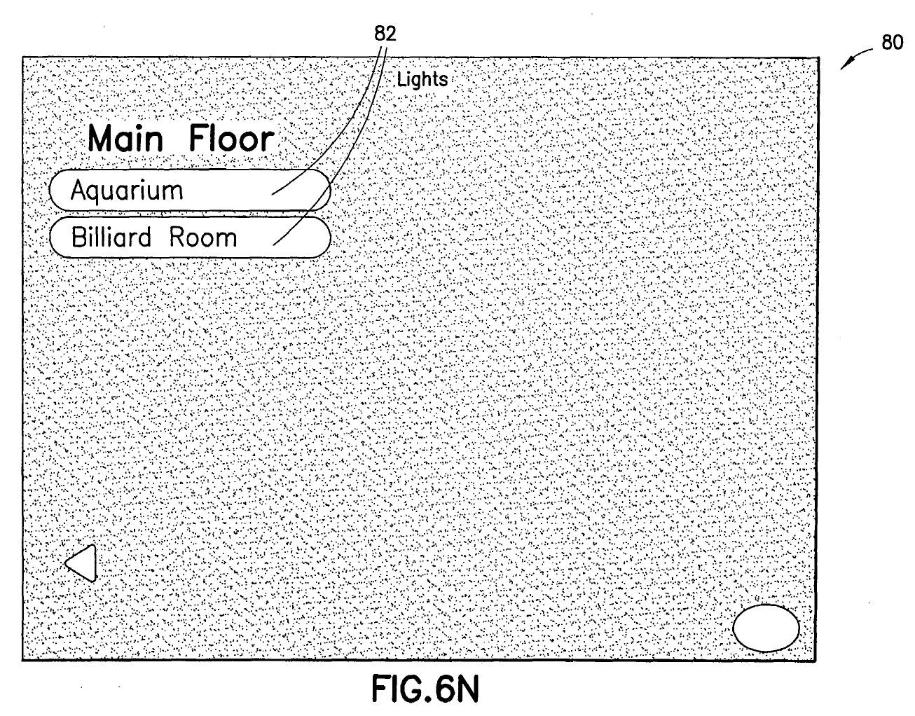

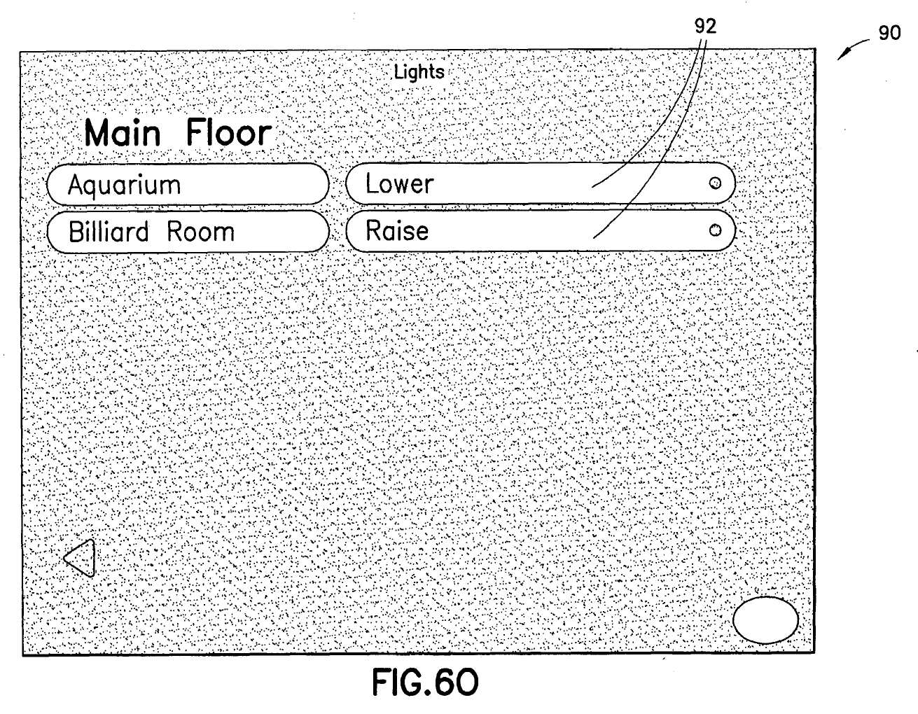

Referring now to FIGS. 5 and 6A-6O, there is shown in FIGS. 6A-O a series of screen shots of exemplary user interfaces that may be displayed by the application residing on processor 20 for creating at least one user interface for processors 22A-22D for controlling devices and/or for controlling (e.g., managing or playing) or utilizing media or data files. In an exemplary embodiment, processor 20 and processors 22A-22D are used in a control system or automation system or the like, and the at least one user interface is a GUI. In an another embodiment, processor 20 is primarily used to create the at least one user interface for use on processors 22A-22D for controlling devices and/or for controlling or utilizing media or data files.

In an exemplary embodiment, FIG. 6A shows a blank page that may be displayed on processor 20 for a new project. Typically, a user will create a project for a controlled space. As discussed above, the term “controlled space” means any space under the control of one or more automation or control systems. In an exemplary embodiment, the present disclosure provides for systems and methods for converting a project's controlled space into a digital format.

As shown in FIG. 6A, when an application of the present disclosure is running, the application generates a window 23 on the display of processor 20. The window 23 includes several frames, namely, frames 24, 26, 28 and 30. A pointer device, such as a mouse, may be used to navigate in window 23. In addition, a tool bar 31 and drop down menu 33 may be provided.

FIG. 6B illustrates one embodiment of a next step in the process of creating at least one user interface for use for controlling devices and/or for controlling (e.g., managing or playing) or utilizing media or data files. In an exemplary embodiment, the application of the present disclosure receives user input to define the “areas” in the controlled space in a hierarchal arrangement 25. In one embodiment and as shown in FIG. 6B, frame 24 is entitled “Area View,” and the upper most level of frame 24 is entitled “Project,” which represents the entire controlled space. In general, the “Area View” 24 shows the project overview by area. For example, the “Area View” 24 shows the physical location of floors, rooms and sub-rooms. Examples of “areas” include, without limitation, floors, rooms, sub-rooms, closets, outside areas, exterior yards, outbuildings, wings, zones, etc. The names and/or icons of each area may be customized for each project. Typically, each project may be divided into areas that match the physical layout of the project. In an exemplary embodiment, the arrangement of areas is automatic in a hierarchal arrangement 25. In one embodiment, when a new area is added, the new area becomes a subordinate of the currently highlighted area.

In one embodiment and as shown in FIG. 6B, the second level of the hierarchy 25 of frame 24 has three entries, namely, “Main Floor” area, “Outside” area and “Upstairs” area. It will be appreciated that the “Main Floor” area, “Outside” area and “Upstairs” area are all areas contained within the controlled space. Under each of the three entries in the second level are entries in the third level. Under the “Main Floor” area entry are listed “Aquarium” area, “Billiard Room” area and “Boiler Room” area. The “Aquarium” area, “Billiard Room” area and “Boiler Room” area are all areas associated with the “Main Floor” area. Typically, these areas will be located on the “Main Floor” area.

As shown in frame 24, under the “Outside” area entry in the second level of the hierarchy 25 there is listed “Deck” area, “Front Porch” area and “Poolhouse” area in the third level. The “Deck” area, “Front Porch” area and “Poolhouse” area are all areas associated with the “Outside” area entry in the previous level.

Under the “Upstairs” area entry in the second level there is listed “Bedroom” area, “Bedroom 2” area and “Master Bedroom” area in the third level. Under the “Master Bedroom” area entry in the third level are listed entries in the fourth level, namely “Closet” area and “Master Bath” area. In an exemplary embodiment, the hierarchy 25 is arranged in a branch-like structure, with each branch of any particular entry collapsible or expandable as indicated by the “+” or “−” sign next to the entry. The hierarchy 25 for the controlled space may have one or more levels. Each level in the hierarchy 25 may have one or more entries. The entries may include areas, such as the identification of a specific area like an “Aquarium” area. The processor application of the present disclosure allows a user to identify any sub-area, control point, object, item and/or load associated with an area.

The entries in any level of the hierarchy 25 may also include objects. An “object” is typically a physical control point within the area, or a load. In an exemplary embodiment and as shown in FIG. 6B, frame 26 is entitled “Vantage Objects.” Frame 26 typically includes a listing of all the different devices, objects and/or items that may be added to a project.

As shown in FIG. 6B, the entries listed in the first level of frame 26 include “Loads,” “Modules,” “Programming,” “Stations, RadioLink,” “Stations, WireLink,” “Styles and Profiles” and “Touchpoints.” A user may select any of the devices, objects and/or items listed in frame 26 and associate them with an area (e.g., by double-clicking an object, or by dragging and dropping an object into an area). Examples of suitable objects or items include, without limitation, home automation equipment (e.g., control devices, controlled devices, modules, loads, keypads, touchscreens, amplifiers, receivers, shade motors, thermostats, dimmers, dimmer stations, relay stations, power stations, user stations, installer stations, sensors, etc.), including those shown in FIGS. 2-4, and/or third-party objects (e.g., third-party IR products, third-party RS-232 products, third-party drivers for blinds, receivers, switchers, CD players, DVD players, security systems, HVAC systems, etc.). In an exemplary embodiment, a user may add an individual object or item to a project (e.g., by double-clicking an object, or by dragging and dropping an object into an area), or a user may add an object or item “group” (e.g., a group of objects or items) to a project (e.g., by double-clicking an object group, or by dragging and dropping an object group into an area).

As depicted in FIG. 6B, in frame 24 the “Aquarium” area entry in the third level is highlighted under the “Main Floor” area entry in the second level. In frame 28, all of the items or objects associated with the “Aquarium” area are shown. In one embodiment, the items or objects associated with the “Aquarium” area include “Load,” “Keypad 1,” and “TP1210 Music.” Also shown in frame 28 are “Area,” “Object Type,” “Parent,” “VID” and “Serial Number” information for each item or object listed. The objects or items associated with other areas may be listed in frame 28 by highlighting the desired area in frame 24.

In one embodiment and as shown in FIG. 6B, the “Load” object row is highlighted in frame 28. In frame 30, entitled “Object Editor,” information on the highlighted “Load” object is shown and can be edited and/or modified by a user. In an exemplary embodiment, a user may use frame 30 for editing the properties of any object, task, timers, etc. Information on other devices, objects or items may be displayed in frame 30 by highlighting the desired device, object or item in frame 28. Graphical representations of each device, object or item, such as, for example, button 39 as shown in FIG. 6C, may or may not be displayed in frame 30 by highlighting each desired device, object or item in frame 28.

As shown in frame 30 of FIG. 6B, the “Load” object in the “Aquarium” area is an incandescent light controlled by the electrical control device identified as “Controller 3: Enclosure 1: Module 1.” In addition, as shown in frame 28, the “Keypad 1” object is a local control point for the highlighted “Load” object. Additional objects or items from frame 26 may be added to the “Aquarium” area. In one embodiment, additional objects or items from frame 26 may be added to the “Aquarium” area by dragging the desired object or item from frame 26 and dropping them into frame 28 when the “Aquarium” area row is highlighted in frame 28, or by dropping them into the “Aquarium” area folder in frame 24. Alternatively, additional objects or items from frame 26 may be added to any area by double-clicking the desired object or item from frame 26.

In an exemplary embodiment and as shown in FIG. 6C, the “Closet” area is highlighted in frame 24. In frame 28, all items or objects associated with “Closet” area are displayed. In frame 28, the “Keypad Station 1” object is highlighted. Information about “Keypad Station 1” is displayed in frame 30. Frame 30 also shows a graphical representation 39 of the “Keypad Station 1” object, in the form of a button 39. The information in frame 30 may be edited and/or modified by a user. For example, one way of associating the “Incandescent Load” object in row #1 of frame 28 with the “Keypad Station 1” object is to drag the “Incandescent Load” object from frame 28 and drop it on the button 39 of the graphical representation of the “Keypad Station 1” in frame 30. Multiple objects or loads may be dragged and dropped onto the button 39 in frame 30. This eliminates the need to program the “Keypad Station 1” object, since the programming is accomplished automatically by dragging and dropping the objects or loads onto the button 39. In addition, in frame 28, “Incandescent Load” object is shown which is controlled by “Controller 3: Enclosure 1: Module 2.” The items or objects in frame 28 may be edited with objects in frame 26. For example, a user may drag objects from frame 26 and drop them into frame 28 in order to edit items or objects in frame 30. The above-mentioned dragging and dropping features of the present disclosure eliminates the need for additional programming to associate each individual device, object or load with the object or item that controls each individual device, object or load.

As shown in FIG. 6D, the “Master Bedroom” area in the third level is highlighted in frame 24. In frame 28, all of the items or objects associated with the “Master Bedroom” area are displayed. There are three loads shown in frame 28, namely, “Load” (row #1), “Incandescent Load” (row #3), and “Incandescent Load” (row #5), which are associated with the “Master Bedroom” area, “Closet” area and “Master Bath” area, respectively. In one embodiment, the associated control point for each of these loads is shown in the row directly beneath them in frame 28 (“Keypad #1,” “Keypad Station 1” and “Keypad Station 1,” respectively).

As shown in FIG. 6D, in frame 28 the “Keypad Station 1” object in row #4 is highlighted. This is directly beneath the “Incandescent Load” in row #3. In frame 30, the “Keypad Station 1” properties are displayed. Further, the “Keypad Station 1” object may be programmed at this point. In one embodiment and as shown in frame 30, the actuator on “Keypad Station 1” is programmed to toggle the “Incandescent Load” in the “Upstairs: Master Bedroom: Closet.”

Similarly, the actuators on any control point may be programmed to carry out any task or set a scene. For example, a control point can be programmed to toggle On/Off the light in the “Master Bedroom” area. FIG. 6E illustrates the same scenario as in FIG. 6D except that the “TouchPoint 1210” object is being added to the “Master Bedroom” area. Once the user has entered in the complete hierarchy 25 for the controlled space, a user interface can then be automatically generated as described below.

FIG. 6F illustrates a window 32 for designing at least one user interface. A work area 35 represents a page in the user interface. The window 32 further includes components 37 that may be dragged and dropped onto the work area 35. Examples of suitable components 37 that may be dragged and dropped onto the work area 35 include, without limitation, generator components, picture components, music components, custom controls, web components, video components, camera components, weather components, HTML components, flash interface components, virtual controls such as buttons, icons or slider bars, or other objects or the like.

FIG. 6G illustrates one embodiment of a “Front Page” of the at least one user interface for the example shown in FIGS. 6A-6E. Navigational buttons 50 in the work area 35 lead to internal pages in the user interface. The navigational buttons 50 may include, for example, “Music,” “Lights” and “Cameras.” In an exemplary embodiment, a user may select any one of the navigational buttons 50 in order to be directed to that particular internal page. For example, by selecting the “Music” navigational button 50, a user thus opens the internal user interface page for “Music.”

FIG. 6H shows the “Lights” page in the work area 35. As depicted in FIG. 6H, the “Lights” page is blank because it has not yet been designed. In an exemplary embodiment, FIG. 6I illustrates a generator component 41 that has been dragged and dropped into the work area 35. The icon 34 labeled “Entertain” in the work area 35 of frame 32 illustrates that generator component 41 has been placed into the work area 35. In an exemplary embodiment, the generator component 41 that has been dragged and dropped into the work area 35 automatically generates a user interface based upon the hierarchy 25 previously created by a user. Stated another way, the information in the hierarchy 25 auto-populates the generator component 41. This type of generator component 41 has hitherto been unknown.

In an exemplary embodiment and as shown in FIG. 6J, an internal window 36 displays the hierarchy 25 in the frame 38. Next to each of the entries in the hierarchy 25 in the frame 38 are check boxes 52. In an exemplary embodiment, a user is prompted to select or de-select the check boxes 52 of any entry of any level of the hierarchy 25. When selected or checked, an entry will be used to populate generator component 41. If not selected, an entry will not populate the generator component 41. In frame 40, all of the controls associated with the selected entries in frame 38 are shown. In an exemplary embodiment, once a user clicks the “OK” button on the bottom of internal window 36, the application of the present disclosure will automatically generate one or more files containing the information to render a user interface based upon the selected entries in the hierarchy 25 made by the user. It will be appreciated that there was no need to independently customize the user interface. The process occurs automatically, and the selected entries in the hierarchy 25 populate the generator component 41 accordingly. The application of the present disclosure eliminates the need for additional programming to associate each individual device or load with the object or item that controls each individual device or load. In an exemplary embodiment, once the hierarchy 25 is created, the user may create another user interface by selecting and/or de-selecting the desired entries in the hierarchy 25 and then click the “OK” button on the bottom of internal window 36 as shown in FIG. 6J.

In an exemplary embodiment, the one or more files generated by the application of the present disclosure containing the information to render a user interface may include a configuration file in the .xml format. In one embodiment, the configuration file may contain all of the necessary information to render the user interface, including, for example, text, graphic file information, graphic position location, etc. Graphical files containing the graphics for the virtual controls to be displayed on the user interface may also be created or included.

As shown in FIG. 6K, an export window 42 is shown as being opened. In an exemplary embodiment, all of the processors in the automated system or control system capable of receiving the user interface created are displayed in the export window 42. In one embodiment, all of the processors are auto-detected and then displayed in the export window 42. The user may then be prompted to select the processors to which the one or more files containing the information to render a user interface are to be exported. Typically, the exported files include the configuration file and the associated graphical files.

In an exemplary embodiment and as shown in FIG. 6L, there is shown a rendered user interface “Front Page” 60 based upon the example shown and described in relation to FIGS. 6A-6K. In exemplary embodiments, the rendered user interface “Front Page” 60 may be displayed on any or all of processors 22A-22D. In one embodiment and as depicted in FIG. 6L, the “Front Page” 60 allows a user to select between navigational buttons or icons 62 labeled “Music,” Lights” and “Cameras.” The rendered user interface “Front Page” 60 may be displayed on each of the processors in the automated system or control system capable of receiving the user interface created (e.g., processors 20 and/or 22A-22D as shown in FIG. 5).

In one embodiment and as shown in FIG. 6M, a “Project” menu page 70 is displayed if the “Lights” navigational button or icon 62 was chosen on the “Front Page” 60 shown in FIG. 6L. As depicted in FIG. 6J and FIG. 6M, the entries in the second level selected in the hierarchy 25 in frame 38 of FIG. 6J (“Main Floor” area, “Outside” area and “Upstairs” area) are displayed in FIG. 6M. Thus, as shown in FIG. 6M, a user now has the option to select between navigational buttons or icons 72 “Main Floor” area, “Outside” area and “Upstairs” area to access lower levels of the hierarchy 25.

FIG. 6N illustrates a “Main Floor” area page 80 if the “Main Floor” area navigational button or icon 72 was chosen in FIG. 6M. As shown in FIG. 6N, the “Main Floor” area page 80 includes navigational buttons or icons 82 “Aquarium” area and “Billiard Room” area. As depicted in FIG. 6J and FIG. 6N, the two selected entries in FIG. 6J under the “Main Floor” area entry are displayed in FIG. 6N. Thus, as displayed in FIG. 6N, a user now has the option to select between navigational buttons or icons 82 “Aquarium” area and “Billiard Room” area.

FIG. 6O depicts an internal “Main Floor” page 90 if the “Aquarium” area navigational button or icon 82 was selected in FIG. 6N. In an exemplary embodiment and as shown in FIG. 6O, virtual control buttons or icons 92 for “Lower” and “Raise” are shown which correspond to the objects and items associated with the “Aquarium” area as shown in window 40 of FIG. 6J. In addition, a comparison of FIG. 6J with FIG. 6B shows the relationship between the hierarchy 25 and the user interface. For example, in an exemplary embodiment, the “Lower” and “Raise” virtual control buttons or icons 92 shown in FIG. 6O correspond to the “Keypad 1” object in the “Aquarium” area as shown in FIG. 6B, frame 28. Thus, in an exemplary embodiment, activating the “Lower” or “Raise” virtual control buttons or icons 92 (e.g., “lower” or “raise” the lights in the aquarium) on the user interface has the same outcome as using the “Keypad 1” control device in the “Aquarium” area. Both the user interface and the “Keypad 1” control device execute the same programming residing on a master controller, as “Keypad 1” may carry out the “Lower” or “Raise” commands via a button on the “Keypad 1” device. In this way, the user interface virtually replicates the “Keypad 1” functionality. That is, the programming associated with the button for “Keypad 1” in FIG. 6B may also be executed via the user interface that was created as depicted in FIG. 6O.

In an exemplary embodiment, the present disclosure provides for a virtual replication of the physical controls for a control system or an automation system or the like. In an exemplary embodiment, the programmed functionality of any physical control point may be replicated virtually as described herein. For example, once a hierarchy for a controlled space is created, a menu-driven user interface may be easily and automatically created. In addition, variations of the user interface may be automatically created by accepting user input to select or de-select items within the hierarchy.

In another embodiment, the present disclosure also provides for a virtual replication of the controls for a media server and/or a media player controlling (e.g., managing or playing) media files. For example, in one embodiment, the present disclosure provides for systems and methods for defining at least one user interface for processor programs for controlling (e.g., managing or playing) media files, and/or for controlling devices in an automation system as well. In an exemplary embodiment, the at least one user interface includes at least one graphical user interface (“GUI”). In another embodiment, the present disclosure provides for systems and methods for defining at least one user interface for processor programs for utilizing data associated with data files, and/or for controlling devices in an automation system as well.

For example, referring back to FIGS. 5 and 6A-6O, processor 20 may be running an application of the present disclosure. In an exemplary embodiment and as shown in FIG. 6F, a music component 43 may be dragged and dropped into a work area 35 of processor 20. The IP address of a processor (not shown) hosting a media server and/or media player may then be entered by a user into processor 20 (e.g., by right clicking in the work area of first processor 10). The music component 43 of processor 20 is then auto-populated with information associated with the media files residing on second processor 12. To accomplish this, in one embodiment, the processor 20 connects over a network to the processor (not shown) running the media server and/or media player. For example, the information on the media files may include, without limitation, album cover art, artists, playlists, genres, songs, etc. In one embodiment, the application of the present disclosure may then automatically generate one or more files (e.g., a configuration file) containing the information to render a user interface based upon the auto-populated information. In an exemplary embodiment, a configuration file is created and graphical files containing any needed graphics are also collected. Once created, the at least one user interface, in the form of one or more files, can be transferred to any or all of processors 22A-22D as shown in FIG. 5, where the at least one user interface can then be rendered and used for control purposes by a user.

In an exemplary embodiment, through the user interface created by the music component 43, playlists may be created on the fly. The playlists may be edited in a number of ways, for example, songs in the playlists may be added or deleted, albums in the playlists may be added or deleted, the playlists may be shuffled and/or repeated, etc. In order to accomplish these functions, an additional application may be added to the processor (not shown) running the media server and/or media player. The processor running the media server and/or media player may be connected to any audio distribution system for quality playback.

In another embodiment, processor 20 may be running an application of the present disclosure. A web component 37 may be dragged and dropped into a work area 35 of processor 20. The IP address of a processor (not shown) hosting a web server having at least one data file may then be entered by a user into processor 20. The web component 37 of processor 20 is then auto-populated with information associated with the at least one data file provided by the web server. For example, the information associated with the at least one data file provided by the web server may include, without limitation, an HTML page, a flash page, user interfaces, GUIs, weather information, stock market information, sports information, RSS News feeds, etc. In one embodiment, an application of the present disclosure may then automatically generate one or more files (e.g., a configuration file) containing the information associated with the at least one data file to render a user interface based upon the auto-populated information. Once created, the at least one user interface, in the form of one or more files, can be transferred to any or all of processors 22A-22D, where the at least one user interface can then be rendered and used for utilization and/or interaction purposes by a user. In one embodiment, the at least one user interface is utilized by a user to utilize data or information associated with the at least one data file to interact with the at least one web server.

In an exemplary embodiment and referring back again to FIG. 1, once at least one user interface is created on first processor 10 for controlling devices and/or for controlling (e.g., managing or playing) or utilizing media or data files or the like on second processor 12, additional processor applications may be added to first processor 10. Examples of suitable additional processor applications include, without limitation, an application for handling communications and files. Also running on processor 10 is an application for rendering the user interface. Program C in the computer program listing is an exemplary program capable of carrying out the features for processor 10.

In one embodiment and in reference to FIG. 1, processor 12 is a media server and/or a media player. An application for handling the communication between processors 10, 12 and controller 14 may also be running on processor 12. In an exemplary embodiment, this application also interfaces with the media server and/or media player through the appropriate API on behalf of processor 10 or controller 14. Program B in the computer program listing is an exemplary program capable of carrying out the features described herein in regards to processor 12.

As explained in relation to FIG. 5, in one embodiment, processor 20 hosts an application for designing a user interface. Programs A and D in the computer program listing are exemplary programs capable of carrying out the features described herein.

Another aspect of the present disclosure includes synchronizing multiple processor applications utilizing or invoking the same services. As used herein, the term “service” means any resource provided by a processor. For example, a service may be a media player. In some instances, multiple processor applications may invoke the same services available on a processor, and problems may arise when the processor applications are not synchronized.

For example, a first processor application may be using a service to play audio from a TV-input out of the sound card of a processor, and a second processor application may request a service on the processor to play a media file (e.g., a music file) stored on the processor. Because the services are running simultaneously, the audio from the TV input and the audio from the media file may be mixed when outputted to speakers. Generally, in many circumstances this an undesirable result. The present disclosure provides for systems and methods to alleviate this problem.

In one embodiment of the present disclosure, in regards to the above scenario, in order to synchronize the first and second applications, the first application may invoke the service to play the media file through the second application. In one embodiment, this causes the second application to stop the audio from the TV-input, and invoke the service to play the media file. The first application then may directly invoke the service to play additional media files. In the case of forming a music queue, for example, the first media file in a playlist may be invoked through other applications. Subsequent media files in the playlist may be invoked directly from the service. Communication between applications and services may be facilitated by using the appropriate API.

Since many changes could be made in the above arrangements and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

1. A system for creating a user interface, comprising:
at least one first processor;
at least one controlled device in communication with the at least one first processor, wherein the at least one controlled device is a processor in communication with (i) at least one media file and (ii) at least one application for managing or playing the at least one media file;
at least one application running on the at least one first processor, wherein the at least one application is programmed to be automatically populated with media-related information associated with the at least one controlled device; and
wherein the at least one application is further programmed to automatically generate at least one file that is configured for creation of at least one user interface that is based at least in part on the media-related information associated with the at least one controlled device.

2. The system of claim 1, wherein the at least one user interface is a graphical user interface.

3. The system of claim 1, wherein the at least one media file is selected from the group consisting of digitally stored music, videos, movies, photographs, sound records, live video, camera images, graphics, album cover graphics and combinations thereof.

4. The system of claim 1, wherein the at least one file to create the at least one user interface is a configuration file.

5. The system of claim 1, wherein the at least one user interface is installed and displayed on the at least one first processor, and wherein the at least one first processor interfaces through at least one application program interface associated with the at least one controlled device to automatically populate the at least one user interface with media-related information associated with the at least one media file to allow a user to utilize the at least one user interface to control the at least one media file.

6. The system of claim 1, further including at least one second processor, wherein the at least one file to create the at least one user interface is transferred from the at least one first processor to the at least one second processor;
wherein the at least one user interface is installed and displayed on the at least one second processor; and
wherein the at least one second processor interfaces through at least one application program interface associated with the at least one controlled device to automatically populate the at least one user interface with media-related information associated with the at least one media file to allow a user to utilize the at least one user interface to control the at least one media file.

7. The system of claim 6, wherein the at least one second processor is a touchscreen processor.

8. The system of claim 1, wherein the at least one file to create the at least one user interface is transferred from the at least one first processor to the at least one controlled device;
wherein the at least one user interface is installed and displayed on the at least one controlled device; and
wherein the at least one controlled device interfaces through at least one application program interface associated with the at least one controlled device to automatically populate the at least one user interface with media-related information associated with the at least one media file to allow a user to utilize the at least one user interface to control the at least one media file.

9. A system for creating a user interface comprising:
at least one first processor;
at least one controlled device in a control system, wherein the control system controls at least one controlled space and wherein the at least one controlled device is controlled by at least one control device;
wherein the at least one controlled space includes at least one area;
at least one controller capable of transmitting command signals to the at least one control device to change the status of the at least one controlled device;
at least one application running on the at least one first processor, wherein the at least one application is programmed to allow a user to define a hierarchy representing the at least one controlled space;
wherein the hierarchy defines a hierarchical relationship for the at least the at least one area, the at least one controlled device, and the at least one control device of the control system; and
wherein the at least one application is further programmed to automatically generate at least one file that is configured for creation of at least one user interface that is based at least in part on the hierarchy representing the at least one controlled space.

10. The system of claim 9, wherein the at least one user interface is a graphical user interface.

11. The system of claim 9, wherein the at least one file to create the at least one user interface is a configuration file.

12. The system of claim 9, wherein the at least one user interface is installed and displayed on the at least one first processor, and
wherein the at least one user interface is utilized by a user to send signals to the at least one controller or to the at least one control device to change the status of the at least one controlled device.

13. The system of claim 12, wherein the at least one user interface is utilized by a user to send signals to the at least one controller or to the at least one control device to change the status of the at least one controlled device by manipulating a virtual control button or icon on the at least one user interface.

14. The system of claim 9, further including at least one second processor, wherein the at least one file to create the at least one user interface is transferred from the at least one first processor to the at least one second processor;
wherein the at least one user interface is installed and displayed on the at least one second processor; and
wherein the at least one user interface is utilized by a user to send signals to the at least one controller or to the at least one control device to change the status of the at least one controlled device.

15. The system of claim 14, wherein the at least one second processor is a touchscreen processor.

16. The system of claim 14, wherein the at least one user interface is utilized by a user to send signals to the at least one controller or to the at least one control device to change the status of the at least one controlled device by manipulating a virtual control button or icon on the at least one user interface.

17. The system of claim 9, wherein the at least one application is further programmed to allow a user to select or de-select at least the at least one area, the at least one controlled device, and the at least one control device and to automatically generate at least one file that is configured for creation of at least one user interface that is based at least in part on the user-selected hierarchy.

18. The system of claim 9, wherein the hierarchy further includes at least one sub-area and at least one object, and wherein the at least one application allows a user to identify each at least one sub-area, each at least one object, each at least one control device, and each at least one controlled device associated with each at least one area.

19. The system of claim 9, wherein the at least one controlled device is selected from the group consisting of electrical devices, loads, lights, lighting equipment, computers, processors, computing equipment, processing equipment, HVAC equipment, motors, shades, fans, outlets, security systems, electronics, electronic equipment, distributed audio systems, televisions, audio/video equipment and combinations thereof.

20. A method for creating a user interface comprising:
providing at least one first processor;
providing at least one controlled device in a control system, wherein the control system controls at least one controlled space and wherein the at least one controlled device is controlled by at least one control device;
wherein the at least one controlled space includes at least one area;
providing at least one controller capable of transmitting command signals to the at least one control device to change the status of the at least one controlled device;
running at least one application on the at least one first processor, wherein the at least one application is programmed to allow a user to define a hierarchy representing the at least one controlled space;
wherein the hierarchy defines a hierarchical relationship for the at least the at least one area, the at least one controlled device, and the at least one control device of the control system;
wherein the at least one application is further programmed to automatically generate at least one file that is configured for creation of at least one user interface that is based at least in part on the hierarchy representing the at least one controlled space; and
generating at least one file that is configured for creation of at least one user interface that is based at least in part on the hierarchy representing the at least one controlled space.

21. A system for creating a user interface, comprising:
at least one first processor;
at least one controlled device in communication with the at least one first processor, wherein the at least one controlled device is a processor in communication with at least one web server and wherein the at least one web server includes at least one data file;
at least one application running on the at least one first processor, wherein the at least one application is programmed to be automatically populated with web-based information associated with the at least one controlled device; and
wherein the at least one application is further programmed to automatically generate at least one file that is configured for creation of at least one user interface that is based at least in part on the web-based information associated with the at least one controlled device.

22. The system of claim 21, wherein the at least one user interface is a graphical user interface.

23. The system of claim 21, wherein the at least one data file is selected from the group consisting of HTML files, flash files, java applets, .xml files, text files, binary files and combinations thereof.

24. The system of claim 21, wherein the at least one file to create the at least one user interface is a configuration file.

25. The system of claim 21, wherein the at least one user interface is installed and displayed on the at least one first processor, and
wherein the at least one user interface is utilized by a user to utilize data associated with the at least one data file.

26. The system of claim 25, wherein the at least one user interface is utilized by a user to utilize data associated with the at least one data file to interact with the at least one web server.

27. The system of claim 21, further including at least one second processor, wherein the at least one file to create the at least one user interface is transferred from the at least one first processor to the at least one second processor;
wherein the at least one user interface is installed and displayed on the at least one second processor; and
wherein the at least one user interface is utilized by a user to utilize data associated with the at least one data file.

28. The system of claim 27, wherein the at least one user interface is utilized by a user to utilize data associated with the at least one data file to interact with the at least one web server.

29. The system of claim 27, wherein the at least one second processor is a touchscreen processor.

30. The system of claim 21, wherein the at least one file to create the at least one user interface is transferred from the at least one first processor to the at least one controlled device;
wherein the at least one user interface is installed and displayed on the at least one controlled device; and
wherein the at least one user interface is utilized by a user to utilize data associated with the at least one data file.

31. The system of claim 30, wherein the at least one user interface is utilized by a user to utilize data associated with the at least one data file to interact with the at least one web server.
